(19) United States
(12) Patent Application Publication
(10) Pub. No.: US 2025/0160324 A1
(43) Pub. Date: May 22, 2025

(54) ACIDIFIED OLEOGEL AND METHODS OF USE

(71) Applicant: University of Massachusetts, Westborough, MA (US)

(72) Inventors: Lynne McLandsborough, Sunderland, MA (US); Shihyu Chuang, Amherst, MA (US)

(21) Appl. No.: 18/931,187

(22) Filed: Oct. 30, 2024

Related U.S. Application Data
(60) Provisional application No. 63/601,785, filed on Nov. 22, 2023.

(51) Int. Cl. A01N 37/02; A01N 25/04; A01N 25/30; A01P 1/00

(52) U.S. Cl. CPC A01N 37/02; A01N 25/04; A01N 25/30; A01P 1/00

(57) ABSTRACT

An acidified oleogel composition includes particular amounts of an organic acid, water, a surfactant, and an oil-structuring agent. The acidified oleogel can be used to provide water-in-oil emulsions, which can be particularly useful in the sanitization of various surfaces including food-contacting surfaces.

### CROSS REFERENCE TO RELATED APPLICATION

This application claims priority to U.S. Provisional Patent Application No. 63/601,785, filed on Nov. 22, 2023, the content of which is hereby incorporated by reference in its entirety.

### FEDERAL RESEARCH STATEMENT

This invention was made with government support under Grant No. 2020-67017-30786 awarded by the National Institute of Food and Agriculture of the United States Department of Agriculture (USDA NIFA). The government has certain rights in the invention.

### BACKGROUND

Low-moisture foods (LMFs) are foods low in moisture content with a water activity (a_{w}) of less than 0.85, which does not support the growth of microorganisms. However, it has been reported that some bacterial pathogens such as Salmonella spp. and Listeria monocytogenes can survive within food matrices for prolonged periods. Salmonella contamination is of particular concern in LMFs such as peanut butter and chocolate as this organism exhibits increased resistance to heat in low-a_{w} environments, which is thought to be a factor contributing to numerous foodborne outbreaks. Although no L. monocytogenes outbreaks have been associated with LMFs, some products containing peanut butter and chocolate have been recalled due to the presence of this organism. In addition, contamination with Salmonella and L. monocytogenes poses a risk to dry pet food manufacturing. Household animals consuming contaminated products can become a source of human infections.

Aqueous-based cleaning and sanitation are undesirable in processing facilities that manufacture low-moisture foods such as peanut butter and chocolate. Alcohol-based sanitization is advantageous because it leaves no residue on the contact surface but requires the processing facility to close temporarily due to flammability.

There remains a continuing need in the art for an antimicrobial formulation suitable for use in a low-moisture food-processing environment.

### SUMMARY

An acidified oleogel comprises 20 to 55 weight percent of an organic acid; 15 to 45 weight percent an aqueous solution; 5 to 30 weight percent of a surfactant; and 1 to 25 weight percent of an oil-structuring agent comprising a fatty acid, a fatty alcohol, a derivative thereof, or a combination thereof; wherein weight percent is based on the total weight of the acidified oleogel.

A method of preparing a water-in-oil emulsion comprises contacting the acidified oleogel with a carrier oil to provide the water-in-oil emulsion.

A water-in-oil emulsion prepared from the acidified oleogel or prepared by the method represents another aspect of the present disclosure.

A method of sanitizing a surface comprises contacting the surface with the acidified oleogel or the water-in-oil emulsion to provide a sanitized surface; wherein the sanitized surface exhibits a microbial log reduction of greater than or equal to 5 relative to the surface prior to the contacting, preferably a microbial log reduction of greater than or equal to 6, or greater than or equal to 6.5.

The above described and other features are exemplified by the following figures and detailed description.

### BRIEF DESCRIPTION OF THE DRAWINGS

The following figures are exemplary embodiments.

FIG. 1A shows the efficacy of various treatment formulations at 22° C. (striped bars) and 45° C. (filled bars) against desiccated Salmonella Enteritidis phage type 30.

FIG. 1B shows the efficacy of various treatment formulations at 22° C. (striped bars) and 45° C. (filled bars) against desiccated Listeria monocytogenes LM25.

FIG. 2A shows the influence of the acetic acid concentration on the efficacy of acidified oil (filled black bars) and acidified water-in-oil (A-W/O) emulsions (striped bars) against desiccated Salmonella Enteritidis phage type 30.

FIG. 2B shows the influence of the acetic acid concentration on the efficacy of acidified oil (filled black bars) and A-W/O emulsions (striped white bars) against desiccated Listeria monocytogenes LM25.

FIG. 3 shows the influence of water dispersion levels on the efficacy of glacial acetic acid-A-W/O emulsion against desiccated Salmonella enterica subsp. enterica serovar Enteritidis phage type 30 (ATCC BAA-1045).

FIG. 4 shows the influence of inoculum preparation methods on the heat resistance (72° C., 2 hours (h)) of Salmonella Enteritidis phage type 30 in peanut butter.

FIG. 5 shows a plot of duration of oil flush (60° C.) against surface cell number.

FIG. 6 shows screening the productions of curli and cellulose by Salmonella enterica subsp. enterica serovars by colony morphology. Shown from left to right columns were S. Michigan (BAA-709), S. Montevideo (BAA-710), S. Gaminara (BAA-711), and S. Enteritidis (BAA-1045). Cells (5 microliters (μL) of an overnight culture adjusted to 0.1 OD₆₀₀) were grown at 22° C. for 96 hours on low-osmolarity LB agar supplemented with Congo Red and Coomassie Brilliant Blue and imaged under normal light (top panel), or supplemented with Calcofluor White and imaged under UV light at 365 nanometers (nm) (bottom panel). The scale bar represented 1 centimeter (cm).

FIG. 7A shows the survival of the hydrated biofilm over incubation at 60° C. with oil (0.33 a_{w}) and 1% v/v water-in-oil (W/O) emulsion (0.92 a_{w}) loaded with 200 mM acetic acid.

FIG. 7B shows the survival of the desiccated biofilm over incubation at 60° C. with oil (0.33 a_{w}) and 1% v/v water-in-oil (W/O) emulsion (0.92 a_{w}) loaded with 200 mM acetic acid.

FIG. 8 shows sensitivity of wet and dry Salmonella Enteritidis biofilms to treatment with acidified oil (0.33 a_{w}, 200 mM acetic acid, 60° C.). The viable cell numbers within hydrated and desiccated biofilms were 8.1 and 6.3 log CFU/coupon, respectively. Rehydration of desiccated biofilms was performed through water immersion (20 minutes) followed by air drying (40 minutes) at room temperature, which did not influence the cell viability. Different lowercase letters indicated significant difference (P<0.05). *, Bacterial survival was reduced to a level negative upon enrichment.

FIG. 9A shows scanning electron microscopy (SEM) of hydrated, non-treated Salmonella Enteritidis biofilms.

FIG. 9B shows scanning electron microscopy of desiccated, non-treated Salmonella Enteritidis biofilms.

FIG. 9C shows scanning electron microscopy of hydrated Salmonella Enteritidis biofilms treated with acidified water-in-oil emulsion.

FIG. 9D shows scanning electron microscopy of desiccated Salmonella Enteritidis biofilms treated with acidified water-in-oil emulsion.

FIG. 10 shows spatial patterns of the CBR-grown biofilms formed by Salmonella Enteritidis phage type 30 strain MB323: the biofilm thickness as hydrated, desiccated, and rehydrated (left); and the confocal microscopy volume view (right). The horizontal line within each data set represented the median. ****, Difference was significant (P<0.0001).

### DETAILED DESCRIPTION

A sanitation protocol based on water is undesirable in LMF-processing environments due to the immiscible nature of water and lipids, and the presence of water residing on the equipment surface can lead to microbial growth. One commercial dry cleaning method applies heated oil to flush out food debris, followed by alcohol-based sanitization. Alcohol-based sanitizers are advantageous in that no residue will be left on the applied surface. However, the processing facility must temporarily close for equipment cooldown after the hot oil rinse as alcohol is flammable, causing production downtime. Thus, developing sanitizers utilizing a heat-stable solvent such as oil would allow the increased frequency and efficiency of cleaning and sanitation.

Dry cleaning is defined as cleaning with little-to-no introduction of water. It is a stress-based approach largely relying on mechanical actions for debris removal. Examples include brushing, scraping, wiping, sweeping, vacuuming, blowing with compressed air, blasting with dry ice, purging with inert liquid or clean/new products, pigging of process lines, and the combinations thereof. Some of these may improve process yield through increasing product recovery, but others may generate fine particles causing transport of allergens and microorganisms across areas with different levels of hygienic zoning. Also, crevices on the equipment may be created by abrasive forces, creating surface topographies advantageous for bacterial attachment and biofilm formation, and thus may increase the chance of fouling. Still, the restriction on water usage outweighs the potential drawbacks.

Contamination with Salmonella enterica remains a principal hazard in low-water activity (a_{w}) foods and across their processing environments due to the resistance of the organism to desiccation and the subsequently induced cross-tolerance. The present inventors have shown that food-grade oil loaded with organic acids is an effective means to tackle desiccated Salmonella. The acidified oil disrupts the structural integrity of bacterial cell membranes and acts synergistically with mild heat treatment. The dispersal of a controlled, low level of water (creation of water-in-oil (W/O) emulsion) was found to enhance the antimicrobial efficacy of the acidified oil by a pronounced margin. The water dispersion allows the partitioning of organic acids from the continuous oil phase to the water droplets which function as another way of entry into the bacterial cytoplasm. This also creates differential osmotic pressure at the interface of the emulsion and desiccated bacteria, facilitating water influx and the antimicrobial actions of organic acids, eventually lysing the cells with damaged membrane. These mechanisms may be further accelerated at elevated temperatures due to a decrease in the viscosity of bacterial cell membranes. Such an oil-based antimicrobial delivery system is a potential non-water-based sanitizer for dry food processing. In a further advantageous feature, the antimicrobial compositions can be provided in the form of a concentrated oleogel, which can be diluted in a carrier oil prior to use, thus providing an improved method of implementing the cleaning procedures described herein on a commercial scale. A significant improvement is therefore provided by the present disclosure.

Accordingly, an aspect of the present disclosure is an acidified oleogel. The term “oleogel” as used herein refers to a gel that has a continuous oil phase. The oleogel has the physical properties of a solid or a semi-solid.

The acidified oleogel comprises an organic acid. The organic acid can be a C₁₋₁₈ organic acid, for example a C₁₋₁₂ organic acid, or a C₁₋₆ organic acid, or a Cia organic acid. The C₁₋₁₈ alkyl chain of the C₁₋₁₈ organic acid can be substituted or unsubstituted, for example substituted with a hydroxyl group. In an aspect, the alkyl chain of the organic acid is unsubstituted, comprising only carbon and hydrogen. Exemplary organic acids can include, but are not necessarily limited to, formic acid, acetic acid, propionic acid, lactic acid, butyric acid, valeric acid, caproic acid, enanthic acid, caprylic acid, pelargonic acid, capric acid, undecylic acid, lauric acid, or a combination thereof. In an aspect, the organic acid can comprise formic acid, acetic acid, propionic acid, lactic acid, or a combination thereof. In an aspect, the organic acid can comprise formic acid, acetic acid, propionic acid, or a combination thereof. In a specific aspect, the organic acid can comprise acetic acid.

The organic acid can be present in the acidified oleogel composition in an amount selected to provide a particular acid concentration upon dilution to form a water-in-oil emulsion, and such a concentration could be determined by one of skill in the art based on the desired application and guided by the present disclosure. For example, the organic acid can be present in the acidified oleogel in an amount of 20 to 55 weight percent, based on the total weight of the acidified oleogel. Within this range, the organic acid can be present in an amount of 25 to 45 weight percent, or 25 to 40 weight percent, or 30 to 45 weight percent, or 30 to 40 weight percent, or 32 to 43 weight percent, or 35 to 39 weight percent, each based on the total weight of the acidified oleogel.

In addition to the organic acid, the acidified oleogel comprises an aqueous solution. The aqueous solution can comprise water, deionized water, a buffer (e.g., phosphate buffered saline, phosphate buffer, and the like), and the like, or a combination thereof. In an aspect, the aqueous solution is water (e.g., deionized water).

The aqueous solution can be present in the acidified oleogel composition in an amount selected to provide a particular aqueous solution (e.g., water) concentration upon dilution to form a water-in-oil emulsion, and such a concentration could be determined by one of skill in the art based on the desired application and guided by the present disclosure. For example, the aqueous solution can be present in an amount of 15 to 45 weight percent, based on the total weight of the acidified oleogel. Within this range, the aqueous solution can be present in an amount of 20 to 40 weight percent, or 25 to 40 weight percent, or 30 to 45 weight percent, or 30 to 40 weight percent, or 27 to 38 weight percent, or 28 to 35 weight percent, each based on the total weight of the acidified oleogel.

In addition to the organic acid and the water, the acidified oleogel further comprises a surfactant. The surfactant can be nonionic, anionic, amphoteric, or zwitterionic. In an aspect, the surfactant can be a nonionic surfactant. Nonionic surfactants suitable can include alkoxylated surfactants, for example ethylene oxide (EO)/propylene oxide (PO) copolymers, capped EO/PO copolymers, alcohol alkoxylates, capped alcohol alkoxylates, mixtures thereof, or the like. In an aspect, the surfactant can have a hydrophilic-lipophilic balance (HLB) value of less than 10.

In an aspect, the surfactant can be a nonionic surfactant derived from a polyhydric alcohol and a C₁₂₋₂₄ fatty acid. Exemplary surfactants can include, but are not limited to, polyoxyethylene sorbitan monooleate (Tween™ 80), polyoxyethylene sorbitan monostearate (Tween™ 60), sorbitan monooleate (SMO or Span™ 80), sorbitan monostearate (SMS or Span™ 60), glyceryl monooleate (GMO), glyceryl monostearate (GMS); glyceryl monopalmitate (GMP), polyglyceryl ester of lauric acid (i.e., polyglyceryl polylaurate (PGPL)), polyglyceryl ester of stearic acid (i.e., polyglyceryl polystearate (PGPS)), polyglyceryl ester of oleic acid (i.e., polyglyceryl polyglyceryl (PGPO)), and ricinoleic acid polyglyceryl ester (PGPR). In a specific aspect, the surfactant comprises polyglycerol polyricinoleate, a sorbitan ester, lecithin, or a combination thereof. In a specific aspect, the surfactant comprises polyglycerol polyricinoleate.

The surfactant can be present in the acidified oleogel composition in an amount selected to provide a particular surfactant concentration upon dilution to form a water-in-oil emulsion, and such a concentration could be determined by one of skill in the art based on the desired application and guided by the present disclosure. For example, the surfactant can be present in the acidified oleogel in an amount of 5 to 30 weight percent, based on the total weight of the acidified oleogel. Within this range, the surfactant can be present in an amount of 5 to 25 weight percent, or 10 to 30 weight percent, or 10 to 25 weight percent, or 12 to 25 weight percent, or 15 to 25 weight percent, or 15 to 22 weight percent, each based on the total weight of the acidified oleogel.

In addition to the organic acid, the aqueous solution, and the surfactant, the acidified oleogel further comprises an oil-structuring agent. The oil-structuring agent comprises a fatty acid, a fatty alcohol, a derivative thereof, or a combination thereof.

In an aspect, the oil-structuring agent can comprise a C₁₀₋₃₀ fatty acid, a C₁₂₋₃₀ fatty alcohol, a triglyceride comprising C₁₀₋₃₀ alkyl groups, or a combination thereof. Other exemplary oil-structuring agents can include, for example, food-grade waxes and amphiphilic polysaccharides (e.g., cellulose derivatives including ethyl cellulose, methyl cellulose, and hydroxypropyl methylcellulose).

The oil-structuring agent can preferably have a melting point of greater than 20° C., or greater than 25° C. For example, the oil-structuring agent may have a melting point of 25 to 100° C., or 25 to 75° C., or 25 to 50° C., or 45 to 100° C., or 45 to 75° C., or 65 to 95° C.

Exemplary oil-structuring agents can comprise or be derived from a saturated fatty acid having 12-24 carbon atoms, for example arachidic acid, behenic acid, stearic acid, lauric acid, lignoceric acid, myristic acid, palmitic acid, and the like or a combination thereof. In a specific aspect, the oil-structuring agent can comprise stearyl alcohol, stearic acid, or a combination thereof.

The oil-structuring agent can be present in the acidified oleogel composition in an amount selected to provide a particular oil-structuring agent concentration upon dilution to form a water-in-oil emulsion, and such a concentration could be determined by one of skill in the art based on the desired application and guided by the present disclosure. For example, the oil-structuring agent can be present in an amount of 1 to 25 weight percent, based on the total weight of the acidified oleogel. Within this range, the oil-structuring agent can be present in an amount of 1 to 20 weight percent, or 5 to 25 weight percent, or 5 to 20 weight percent, or 1 to 18 weight percent, or 5 to 18 weight percent, or 8 to 25 weight percent, or 8 to 18 weight percent, or 10 to 15 weight percent, each based on the total weight of the acidified oleogel.

In a specific aspect, the acidified oleogel can comprise 32 to 43 weight percent of the organic acid; 25 to 35 weight percent water; 15 to 25 weight percent of the surfactant; and 8 to 18 weight percent of the oil-structuring agent; wherein weight percent is based on the total weight of the acidified oleogel.

In another specific aspect, the acidified oleogel can comprise 32 to 43 weight percent of the organic acid; 25 to 35 weight percent water; 15 to 25 weight percent of the surfactant; and 8 to 18 weight percent of the oil-structuring agent; wherein weight percent is based on the total weight of the acidified oleogel, and wherein the organic acid comprises acetic acid; the surfactant is derived from a polyhydric alcohol and a C₁₂₋₂₄ fatty acid; and the comprises a C₁₂₋₃₀ fatty acid, a C₁₂₋₃₀ fatty alcohol, a triglyceride comprising C₁₂₋₃₀ alkyl groups, or a combination thereof and has a melting point of greater than 20° C., preferably greater than 25° C.

The acidified oleogel according to the present disclosure is a solid at room temperature (e.g., 20 to 25° C.). The solid acidified oleogel does not spontaneously flow at a temperature of 20 to 25° C. (i.e., with no applied pressure). The acidified oleogel can advantageously have a melting temperature of 40° C. or more, for example 45° C. or more, for example 45 to 100° C. Such a melting temperature can facilitate further processing of the acidified oleogel.

The acidified oleogel can be prepared by combining the components of the acidified oleogel to provide the acidified oleogel. In some aspects, it may be desirable to provide an acidified oleogel precursor composition comprising the surfactant, water, and the oil-structuring agent. The organic acid can be added to the acidified oleogel precursor composition to provide the acidified oleogel.

The acidified oleogel according to the present disclosure can be particularly useful in the preparation of water-in-oil emulsions. Thus, a water-in-oil emulsion prepared from the acidified oleogel represents another aspect of the present disclosure. The water-in-oil emulsion can be prepared by dilution of the acidified oleogel concentrate with a carrier oil to provide the desired water-in-oil emulsion. A suitable dilution factor can be determined by the skilled person guided by the present disclosure depending on the desired concentrations of various components in the final emulsion (e.g., organic acid concentration, water concentration, etc.). In an aspect, the water-in-oil emulsion can be prepared by combining the acidified oleogel and the carrier oil in a volume ratio of acidified oleogel:carrier oil of 1:1 to 1:100, or 1:1 to 1:75, or 1:1 to 1:50, or 1:5 to 1:50, or 1:10 to 1:50, or 1:20 to 1:40.

In some aspects, a water-in-oil emulsion can be prepared by combining the organic acid, the surfactant, the aqueous solution, and a carrier oil. Stated another way, acidified water-in-oil emulsions can be prepared directly. Using a direct preparation method, the presence of the oil-structuring agent may not be required. The acidified water-in-oil emulsion prepared by the direct method can comprise an organic acid concentration of 50 to 500 millimolar, or 100 to 300 millimolar, or 150 to 250 millimolar, based on the total volume of the water-in-oil emulsion, and a water concentration of 0.1 to 1 weight percent, or 0.1 to 0.5 weight percent, or 0.2 to 0.5 weight percent, or 0.1 to 0.4 weight percent, each based on the total weight of the water-in-oil emulsion. An exemplary direct method is further described in the working examples below.

The composition of the acidified oleogel and the respective amounts of the acidified oleogel and the carrier oil can be selected so as to provide a water-in-oil emulsion having a desired composition, selected to suit a particular end-use application. For example, in an aspect, the acidified oleogel can be contacted with the carrier oil in an amount effective to provide an organic acid concentration of 50 to 500 millimolar, or 100 to 300 millimolar, or 150 to 250 millimolar, based on the total volume of the water-in-oil emulsion. In an aspect, the acidified oleogel can be contacted with the carrier oil in an amount effective to provide a water concentration of 0.1 to 1 weight percent, or 0.1 to 0.5 weight percent, or 0.2 to 0.5 weight percent, or 0.1 to 0.4 weight percent, each based on the total weight of the water-in-oil emulsion. In an aspect, the acidified oleogel can be contacted with the carrier oil in an amount effective to provide a surfactant concentration of 0.1 to 5 weight percent, or 0.5 to 3 weight percent, or 0.75 to 2 weight percent, or 0.9 to 1.5 weight percent, each based on the total weight of the water-in-oil emulsion.

The carrier oil can preferably comprise an edible oil, a food-grade mineral oil, saturated and/or aromatic hydrocarbons (e.g., paraffins), medium chain triglycerides (e.g., triglycerides having two or three aliphatic C₆₋₁₂ alkyl chains), or a combination thereof.

In an aspect, the carrier oil can comprise an edible oil. Various types of edible oils can be used, for example including but not limited to soybean oil, olive oil, canola oil, corn oil, sunflower oil, safflower oil, coconut oil, cotton seed oil, linseed oil, almond oil, peanut oil, algae oil, palm oil, palm stearin, palm olein, hydrogenated palm oil, hydrogenated palm stearin fat, high oleic soybean oil, high oleic canola oil, high oleic sunflower oil, high oleic safflower oil, fully hydrogenated soybean oil, fully hydrogenated canola oil, fully hydrogenated cotton seed oil, fully hydrogenated sunflower oil, and the like, or a combination thereof. In an aspect, the carrier oil can comprise soybean oil, olive oil, canola oil, palm oil or a combination thereof. In a specific aspect, the carrier oil can comprise canola oil.

In an aspect, a water-in-oil emulsion prepared from the acidified oleogel can comprise 0.5 to 5 weight percent of the organic acid; 0.1 to 5 weight percent of the surfactant; 0.1 to 1 weight percent water; 0.1 to 5 weight percent of the oil structuring agent; and a carrier oil; wherein weight percent is based on the total weight of the water-in-oil emulsion. In an aspect, a water-in-oil emulsion prepared from the acidified oleogel can comprise 0.5 to 5 weight percent of the organic acid; 0.1 to 3 weight percent of the surfactant; 0.1 to 3 weight percent water; 0.1 to 5 weight percent of the oil structuring agent; and a carrier oil; wherein weight percent is based on the total weight of the water-in-oil emulsion. In an aspect, a water-in-oil emulsion prepared from the acidified oleogel can comprise 0.5 to 3 weight percent of the organic acid; 0.1 to 3 weight percent of the surfactant; 0.1 to 3 weight percent water; 0.1 to 5 weight percent of the oil structuring agent; and a carrier oil; wherein weight percent is based on the total weight of the water-in-oil emulsion.

The water-in-oil emulsion can comprise water droplets dispersed in the carrier oil matrix. In an aspect, the water droplets can have an average diameter of 100 to 1000 nanometers dispersed in the carrier oil. Water droplet size can be determined, for example, using dynamic light scattering (DLS) as further described in the working examples below.

In another advantageous feature, the water-in-oil emulsion is not flammable, for example in the temperature range of 40 to 70° C.

The acidified oleogel and the water-in-oil emulsion can optionally exclude other components not specifically described herein. For example, an ionic surfactant can be excluded from the composition. In an aspect, an alcohol solvent can be excluded from the composition. For example, a lower chain alcohol such as a C₂₋₆ or a C₂₋₄ alcohol can be excluded from the composition. In an aspect, ethanol can be excluded from the composition. In an aspect, a dicarboxylic acid compound (i.e., comprising two —COOH groups) can be excluded from the composition. In an aspect, an acid other than the organic acid can be excluded from the composition. For example, the composition can exclude phosphoric acid, sulfuric acid, nitric acid, methyl sulfonic acid, a peroxy acid, and the like or a combination thereof. In some aspects, the water-in-oil emulsion does not include the oil-structuring agent, for example when the emulsion is not prepared from the concentrated acidified oleogel.

The acidified oleogel and the water-in-oil emulsions prepared therefrom can be especially useful as antimicrobial compositions. Accordingly, another aspect of the present disclosure is a method of reducing a population of microorganisms on an object. The term “microorganisms,” as used herein, refers to any noncellular or unicellular (including colonial) organism. Microorganisms include all prokaryotes. Microorganisms can include bacteria (including cyanobacteria), lichens, microfungi, protozoa, virinos, viroids, viruses, and some algae. As used herein, the term “microbe” is synonymous with microorganism.

The method can comprise contacting the object with the acidified oleogel or the water-in-oil emulsion. The contacting may be, for example, at a temperature of 0 to 100° C., or 25 to 90° C., or 25 to 80° C., or 45 to 80° C., or 50 to 75° C. and for a time of 1 minute to 2 hours, or 1 minute to 1.5 hours, or 10 minutes to 1.5 hours, or 30 minutes to 1.5 hours, or 1 to 60 minutes, or 1 to 45 minutes, or 10 to 40 minutes. Advantageously, after the contacting, the object can exhibit at least a 5-log order reduction in the population of the microorganism, or at least a 6-log order of reduction, or at least a 6.5-log order of reduction in the population of the microorganism. The microorganism can comprise, for example, spores, bacteria, mold, yeast, viruses, and mixtures thereof.

Another aspect of the present disclosure is a method of sanitizing a surface, for example a food-contacting surface (e.g., a food processing or manufacturing surface). The terms “food processing surface” or “food-contacting surface,” as used herein, refer to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), surfaces of food processing wares (e.g., utensils, dishware, wash ware, and bar glasses), and surfaces of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, sanitizing gels, cooling towers, food processing antimicrobial garment sprays, and non-to-low-aqueous food preparation lubricants, oils, and rinse additives.

The method can comprise contacting a surface with the acidified oleogel or the water-in-oil emulsion to provide the sanitized surface. The sanitized surface can advantageously exhibit a microbial log reduction of greater than or equal to 5 relative to the surface prior to the contacting, preferably a microbial log reduction of greater than or equal to 6, or greater than or equal to 6.5.

The surface can be any food-contacting surface in need of sanitization. The surface can be, for example, stainless steel, titanium, glass, plastic, ceramic, concrete, silicone, polytetrafluoroethylene (e.g., Teflon™), or rubber (e.g., neoprene, ethylene propylene diene monomer, acrylonitrile butadiene (e.g., Buna-N)). In an aspect, the surface is a food-processing surface, for example tubing which may come into contact with a food product, for example during a manufacturing process. The present method may be particularly useful in food processing equipment which handles low moisture foods, for example peanut butter or chocolate. In an aspect, the method can be a clean-in-place (CIP) method or a sanitize-in-place (SIP) method for cleaning or sanitizing equipment in the food industry. As used herein, CIP cleaning techniques are a specific cleaning and disinfection regimen adapted for removing soils from the internal components of tanks, lines, pumps and other process equipment used for processing product streams. Clean in place cleaning involves passing cleaning solutions (e.g., the water-in-oil emulsion according to the present disclosure) through the system without dismantling any system components. The minimum clean-in-place technique involves passing the cleaning solution through the equipment and then resuming normal processing.

The surface can comprise a microorganism, for example bacteria, bacterial spores, or the like. The bacteria may be present on the surface in the form of a biofilm. A “biofilm” refers to a population of bacteria attached to an inert surface. In an aspect, the microorganism can be a food-borne pathogenic bacteria associated with a food product, for example (but not limited to) Salmonella, Campylobacter, Listeria, Escherichia coli, yeast, and mold.

Contacting the acidified oleogel or the water-in-oil emulsion with the contaminated surface can effectively kill the microorganism (e.g., bacterial cells) present on the surface. Accordingly, the compositions disclosed herein can be particularly useful as disinfectants or antimicrobial compositions. The contacting can be, for example, at a temperature of 0 to 100° C., or 25 to 90° C., or 25 to 80° C., or 45 to 80° C., or 50 to 75° C. and for a time of 1 minute to 2 hours, or 1 minute to 1.5 hours, or 10 minutes to 1.5 hours, or 30 minutes to 1.5 hours, or 1 to 60 minutes, or 1 to 45 minutes, or 10 to 40 minutes.

In an aspect, the method can optionally further comprise first contacting the surface with a heated oil (e.g., oil at a temperature of greater than 25° C.). The heated oil may optionally comprise an organic acid as described above. Contact with the heated oil can occur prior to contact with the acidified oleogel or the water-in-oil emulsion.

This disclosure is further illustrated by the following examples, which are non-limiting.

### EXAMPLES

Materials and methods used in the following examples are described below.

Bacterial Strains. Salmonella enterica subsp. enterica serovar Enteritidis phage type 30 (ATCC BAA-1045, an outbreak strain associated with raw almonds) (Isaacs et al., 2005), Enterococcus faecium (ATCC 8459, or NRRL B-2354 under the USDA-ARS culture collection), and Escherichia coli O157:H7 (ATCC 43888, a nontoxigenic strain) were obtained from the American Type Culture Collection (Manassas, VA). Cryo-cultures were maintained at −80° C. in tryptic soy broth (TSB, Difco, Becton Dickinson, Sparks, MD) supplemented with 25% glycerol (#G7893, Sigma-Aldrich, St. Louis, MO). Working cultures were prepared by streaking cryo-cultures on tryptic soy agar (TSA, Difco, Becton Dickinson) plates with overnight incubation at 37° C., which were maintained at 4° C. and replaced monthly.

Broth-based inoculum was prepared by transferring an isolated colony from the working culture to TSB (20 mL) with incubation at 37° C. for 18 h with shaking at 150 rpm. This liquid culture was spread over TSA supplemented with 0.6% yeast extract (TSAYE, #BP1422, Fisher Scientific, Pittsburgh, PA) in 100 mm×15 mm petri dishes with incubation at 37° C. for 24 h to produce bacterial lawns.

Bacterial Desiccation. A bacterial desiccation system was used for screening Salmonella surrogates against oil-based antimicrobials. In this context, the TSAYE lawns were scraped off (#353085, Falcon) and re-suspended in distilled water to 10⁹ CFU/mL. Aliquots (20 L) were placed on stainless-steel coupons (2B-finish, 12.7 mm diameter×3.8 mm thickness, Biosurface, Bozeman, MT) and held in a desiccator at room temperature (20-22° C.) for 20 h. Such drying process did not influence the viable counts of the organisms grown as bacterial lawns tested (data not shown), and thus the final cell density was determined at 2×10⁷ CFU/coupon. Saturated solutions of sodium chloride (#S271-1, Fisher Scientific) and magnesium chloride (#7786-30-3, Sigma-Aldrich) were used to control the equilibrium relative humidity (ERH) at 75% and 33%, respectively, as confirmed with a hygrometer. Used coupons were washed in soapy water with glass beads and quaternary ammonium compound-based sanitizers, rinsed with distilled water, soaked in acetone overnight, rinsed with distilled water, sonicated, autoclaved, and dried to allow reuse.

Inoculation of peanut butter. Commercial creamy peanut butter (contains roasted peanuts, sugar, and ≤2% of molasses, fully hydrogenated rapeseed and soybean oils, mono and diglycerides, and salt) and refined canola oil were purchased from a local wholesaler (Hadley, MA). The TSAYE lawns (10 plates) were scraped off, added to and vortexed (2 min) with canola oil (40 mL) in a conical tube (#352098, Falcon), added to and manually mixed (30 s) with peanut butter (160 g) in a stomacher bag (#B01196, Whirl-Pak), and then mixed with a stomacher for 2× 5 min (#3068-49, Weber Scientific, NJ). The inoculum was prepared as an oil suspension to minimize changes in the a_{w} of peanut butter, based upon reports that the thermal inactivation kinetics of microorganisms in foods is a function of the prevailing a_{w} and moisture content of the food matrix. The typical a_{w} peanut butter is 0.35 or less. As with our samples, the a_{w} of peanut butter was 0.27 prior to inoculation as measured with a Dewpoint a_{w} meter at 22° C. (AquaLab, Meter Group, Pullman, WA), which increased to 0.30 after inoculation due to mixing with the inoculum prepared as an oil suspension.

Tubing setup and contamination. Polyvinyl chloride (PVC) tubing (#8701-9090, Nalgene, Thermo Fisher Scientific, MA) was pre-cut into sections of 7 foot in length, autoclaved, and equilibrated at 60° C. On the day of experiment, the 7′ tubing was connected to a positive displacement pump (Masterflex L/S series, Cole-Parmer, IL) and kept within a dedicated incubator for experimentation at 60° C. Tubing was disposed of after each trial. Contamination of tubing was performed based upon the procedure by Grasso et al. (2015). In brief, inoculated peanut butter was cycled through the tubing, at 60° C. for 15 min, to minimize uneven distribution. Such thermal process did not influence the viable counts of the organisms tested (data not shown). Thereafter, peanut butter samples were taken from the tubing exit (i.e., the system discharge) to determine the initial level of contamination, which was recorded at 10⁸⁻⁹ CFU/g.

Cleaning with heated oil. Canola oil was portioned, as appropriate, and equilibrated at 60° C. prior to the day of experiment. The microflora in the heated oil was determined as the most probable number (MPN), which was less than 3 MPN/mL with a three-tube method (Blodgett, 2010). For cleaning, the heated oil (non-acidified) was flushed through the contaminated tubing at a constant flow rate to allow cleaning of tube walls with controlled shear. The discharge was not cycled back to the tubing. The velocity of the oil flush was defined as:

$$V = Q / A \qquad Equation ( 1 )$$

where V is the flow velocity (m/s), Q is the volumetric flow rate (m³/s), and A is the cross-sectional area of tubing (m²). To determine the flow type of the oil flush, the Reynolds number was calculated as:

$${N}_{R e} = ρ VD / μ \qquad Equation ( 2 )$$

where N_{Re} is the Reynolds number (dimensionless), ρ is the fluid density (kg/m³), V is the flow velocity (m/s), D is the diameter of tubing (m), and μ is the fluid dynamic viscosity (kg/m·s).
Sanitization with Oil-Based Antimicrobials.

Preparation of acidified oil and acidified W/O emulsions. Glacial acetic acid (#A6283, Sigma-Aldrich) was dissolved in canola oil to 500 mM (3% w/v) to create acidified oil. This was equilibrated at 60° C. and briefly stirred with a magnetic stir bar prior to experiments.

Acidified W/O emulsion was formulated as a crystallized concentrate consisting of glacial acetic acid, polyglycerol polyricinoleate (PGPR 4150, Palsgaard, Juelsminde, Denmark), distilled water, and a mixture of stearyl alcohol and stearic acid as the oil-structuring agent. Upon use, the concentrate was diluted in fresh oil with continuous stirring at 60° C. for 30 min, to final concentrations of 200 mM acetic acid (1.2% w/v), 0.6% v/v distilled water, and 0.4% w/w PGPR. The droplet size was measured at 0.4 micron (intensity-weighted) with dynamic light scattering using the Zetasizer Nano ZS (Malvern Instruments, Worcestershire, UK) (data not shown). The working concentration of water dispersion was 2× the minimum effective concentration (0.3% by volume) needed to enhance the antimicrobial efficacy of acetic acid-acidified oil by a pronounced margin (i.e., reducing desiccated Salmonella by greater than 6.5 log within 20 min of contact at room temperature).

Treatment. After the contaminated tubing was cleaned by flushing with oil (without acetic acid), acidified oil or acidified W/O emulsion was pumped through the tubing until the residual cleaning oil (approximately 100 mL) was emptied, which, thereafter, remained holding at 60° C. for 30 min as the sanitizing treatment.

Tubing Sampling. The sampling site was selected based upon the probability of contamination. For this, the tubing exit was cut into segments with an inner wall area of 10 cm² each. Up to 3 segments/samples were collected per trial totaling approximately 5% length of the 7′ tubing. To determine the surface cell number after cleaning with heated oil, the tubing segment was swabbed with firm and even pressure using a cotton stick (7 mm diameter cotton head), transferred to TSBYE (20 mL) in a conical tube (#352098, Falcon) with the sample and the cotton head fully submerged, vortexed for 2 min, serially diluted with 0.1% buffered peptone water, and plated on TSAYE with incubation at 37° C. for 24 h. The detection limit of this method was 1.3 log CFU/cm². Alternatively, non-selective enrichment was used for sampling the tubing sanitized with oil-based antimicrobials. In this context, each tubing segment was submerged within TSBYE (20 mL) and incubated at 37° C. for 24 h. Detection of the test organism was indicated by positive enrichments and, subsequently, confirmed by streaking on TSA with overnight incubation at 37° C. The colonies of S. Enteritidis were catalase positive, light cream in color, opaque, circular, convex, and 1-3 mm in diameter with a glistening, smooth surface and an entire, defined edge. Those of E. faecium were catalase negative, white, opaque, circular, convex, and small (<1 mm in diameter) with a glistening, smooth surface and an entire, defined edge.

Statistical Analysis. Experiments were conducted in three independent replicates. Two-way analysis of variance (ANOVA) was performed with the Prism software (v9.5.1, GraphPad, San Diego, CA). Differences were determined statistically significant at P<0.05. Pairwise comparison was performed with the Tukey's post hoc test to denote levels of significance.

### Development of Antimicrobial Water-In-Oil (W/O) Emulsions

The initial screening of acidified W/O emulsions was performed using Span 80 as the surfactant with spontaneous emulsification, which was found to have high antimicrobial efficacy. However, before moving forward, a shelf-life study was performed to compare the effects of different surfactants on stabilizing the emulsion. A difference in stability against gravitational separation was observed between the coarse acidified W/O emulsions that Span 80 and polyglycerol polyricinoleate (PGPR) stabilized. After storage at 22° C. for 14 days, the PGPR-stabilized emulsion remained stable, with only a thin layer of oil rising to the top surface. Such oil-phase separation was more pronounced in the Span 80-stabilized counterpart, in addition to clear water phase separation indicating droplet breakdown. Thus, PGPR was selected for use as the surfactant in subsequent experiments.

### Antimicrobial Efficacy of Acidified Oil and W/O Emulsions

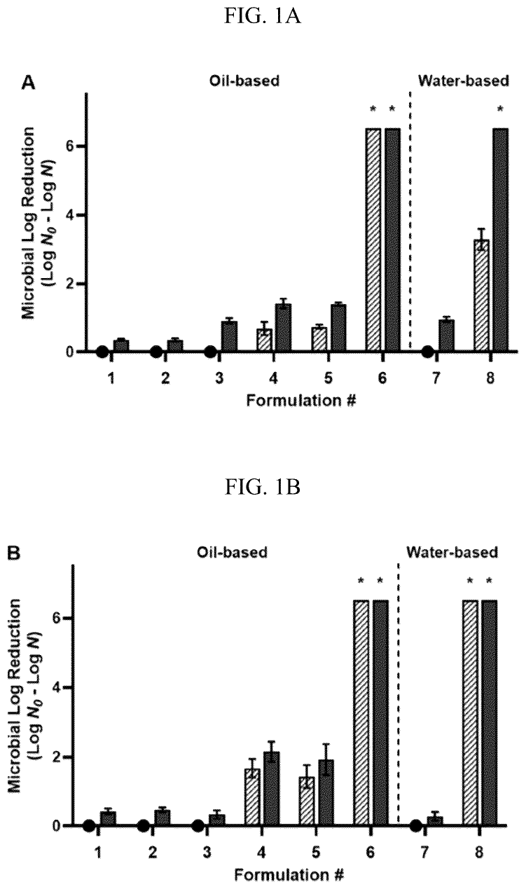

The oil-based delivery of acetic acid was tested against one strain of each organism for efficient screening, i.e., Salmonella enterica serovar Enteritidis phage type 30 and L. monocytogenes LM25. A 30-min contact time with 200 mM acetic acid was used against cells desiccated to 75% equilibrium relative humidity (ERH). Nonacidified controls included oil alone, oil with the surfactant, W/O emulsion (with 3% [vol/vol] distilled water), and water alone. As shown in FIG. 1, these treatments did not affect the desiccated bacteria at 22° C. but resulted in microbial log reductions (MLRs) of less than 1 log CFU/coupon at 45° C. With acidified oil, the presence of the surfactant did not affect the antimicrobial efficacy (P>0.05). At 22° C., acidified oils with 200 mM acetic acid with and without PGPR reduced desiccated S. Enteritidis by 0.69 and 0.74 log CFU/coupon, respectively, and reduced desiccated L. monocytogenes by 1.67 and 1.43 log CFU/coupon, respectively. At 45° C., acidified oils with 200 mM acetic acid with and without PGPR reduced desiccated S. Enteritidis by 1.42 and 1.40 log CFU/coupon, respectively, and reduced desiccated L. monocytogenes by 2.15 and 1.92 log CFU/coupon, respectively. However, as 3% water was dispersed within the acidified oil with the surfactant to create acidified W/O emulsions as the treatment, both S. Enteritidis and L. monocytogenes numbers were reduced to below the detection limit of 0.48 log most probable number (MPN)/coupon (i.e., a reduction of >6.52 log MPN/coupon), with and without heating.

For comparison, acetic acid dissolved in water was tested. Acetic acid in water (200 mM) reduced desiccated S. Enteritidis by 3.28 log CFU/coupon at 22° C., which increased to >6.52 log MPN/coupon at 45° C. At both temperatures, desiccated L. monocytogenes was reduced by >6.52 log MPN/coupon. Without acetic acid, desiccated S. Enteritidis was more sensitive to water heating than oil (P>0.05). However, the dispersion of 3% water within the oil offset such a difference. These dry- and wet-heat phenomena were not observed for desiccated L. monocytogenes.

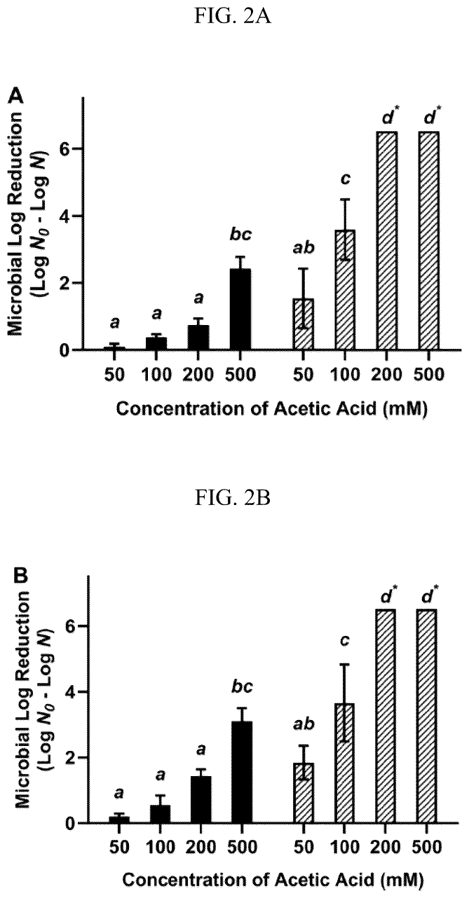

The influence of the acetic acid concentration on the antimicrobial efficacy of acidified oil and acidified W/O emulsions (3% water) was investigated, and the results are shown in FIG. 2. A 30-min contact time at 22° C. was used against cells desiccated to 75% ERH. Acidified oils with 50, 100, 200, and 500 mM acetic acid reduced desiccated S. Enteritidis by 0.10, 0.38, 0.74, and 2.41 log CFU/coupon, respectively (FIG. 2A, black bars), and reduced desiccated L. monocytogenes by 0.20, 0.55, 1.43, and 3.11 log CFU/coupon, respectively (FIG. 2B, black bars). Acidified W/O emulsions with 50 and 100 mM acetic acid reduced desiccated S. Enteritidis by 1.53 and 3.59 log CFU/coupon, respectively, which increased to >6.52 log MPN/coupon with >200 mM acetic acid (FIG. 2A, striped bars). Similar results were observed when L. monocytogenes was treated with acidified W/O emulsions, with acetic acid levels of 50 and 100 mM reducing the numbers of desiccated L. monocytogenes cells by 1.84 and 3.66 log CFU/coupon, respectively, which increased to >6.52 log MPN/coupon with ≥200 mM acetic acid (FIG. 2B, striped bars). The influence of the acetic acid concentration was statistically significant by analysis of variance (ANOVA) (P>0.05). The difference between acidified oil and acidified W/O emulsions was also statistically significant at each acetic acid concentration. Thus, 200 mM acetic acid in W/O emulsions was selected for subsequent experiments.

### Effect of Stabilization Method of Oil-Continuous Colloids

Efficacy of acidified oil-continuous colloidal systems stabilized by different methods against desiccated Salmonella enterica subsp. enterica serovar Enteritidis phage type 30 (ATCC BAA-1045) was evaluated, and the results are shown in Table 1. All formulations contained 200 mM glacial acetic acid as per final solution volume. Treatment efficacy was evaluated based upon a 30-min contact time against the bacterial cells desiccated at 75% equilibrium relative humidity for 20 h prior to testing. The inoculum level was 7 log CFU per stainless-steel coupon, and the detection limit was 0.5 log Most Probable Number/coupon. When bacterial survival was reduced to below this point, the outcome was interpreted as greater than 6.5 log MPN/coupon reductions.

TABLE 1

| Stabilization | Mean microbial log reduction | | | |
|---|---|---|---|---|
| method of acidified | Without water | | With 3% v/v water | |
| oil-continuous colloids | 22° C. | 45° C. | 22° C. | 45° C. |
| Low-energy | 0.69 ± 0.06 | 1.42 ± 0.14 | >6.5 | >6.5 |
| emulsification^{a} | | | | |
| High-energy | 0.74 ± 0.19 | 1.40 ± 0.05 | >6.5 | >6.5 |
| emulsification^{b} | | | | |
| Pickering | 0.22 ± 0.13 | 0.97 ± 0.28 | >6.5 | >6.5 |
| stabilization^{c} | | | | |

^{a}Coarse emulsions were formed by mixing distilled water with oil, organic acid, and a nonionic surfactant under continuous stirring at 700 rpm for 30 min at room temperature.
^{b}Fine emulsions were produced by passing the coarse emulsions through a microfluidizer (M-110L, Microfluidics, Newton, MA) at 12 kpsi at room temperature for 2 cycles.
^{c}Surface-treated hydrophobic silica nano-particles were loaded into oil using a high-shear mixer (M133/1281-0, Biospec Products, Inc., ESGC, Switzerland) at room temperature for 2 min, creating a colloidal network of insoluble particles immobilizing the liquid components.

Efficacy of acidified oil-continuous colloidal systems stabilized by different methods against desiccated Listeria monocytogenes (LM25, Cornell University Listeria strain collection isolation no. FSL-J1-110) was evaluated and the results are shown in Table 2. All formulations contained 200 mM glacial acetic acid as per final solution volume. Treatment efficacy was evaluated based upon a 30-min contact time against the bacterial cells desiccated at 75% equilibrium relative humidity for 20 h prior to testing. The inoculum level was 7 log CFU per stainless-steel coupon, and the detection limit was 0.5 log Most Probable Number/coupon. When bacterial survival was reduced to below this point, the outcome was interpreted as greater than 6.5 log MPN/coupon reductions.

TABLE 2

| Stabilization method | Mean microbial log reduction | | | |
|---|---|---|---|---|
| of acidified oil- | Without water | | With 3% v/v water | |
| continuous colloids | 22° C. | 45° C. | 22° C. | 45° C. |
| Low-energy | 1.67 ± 0.27 | 2.15 ± 0.29 | >6.5 | >6.5 |
| emulsification^{a} | | | | |
| High-energy | 1.43 ± 0.33 | 1.92 ± 0.45 | >6.5 | >6.5 |
| emulsification^{b} | | | | |
| Pickering | 0.14 ± 0.07 | 0.67 ± 0.18 | 0.32 ± 0.19 | >6.5 |
| stabilization^{c} | | | | |

^{a}Coarse emulsions were formed by mixing distilled water with oil, organic acid, and a nonionic surfactant under continuous stirring at 700 rpm for 30 min at room temperature.
^{b}Fine emulsions were produced by passing the coarse emulsions through a microfluidizer (M-110L, Microfluidics, Newton, MA) at 12 kpsi at room temperature for 2 cycles.
^{c}Surface-treated hydrophobic silica nano-particles were loaded into oil using a high-shear mixer (M133/1281-0, Biospec Products, Inc., ESGC, Switzerland) at room temperature for 2 min, creating a colloidal network of insoluble particles immobilizing the liquid components.

### Influence of Water Dispersion Level

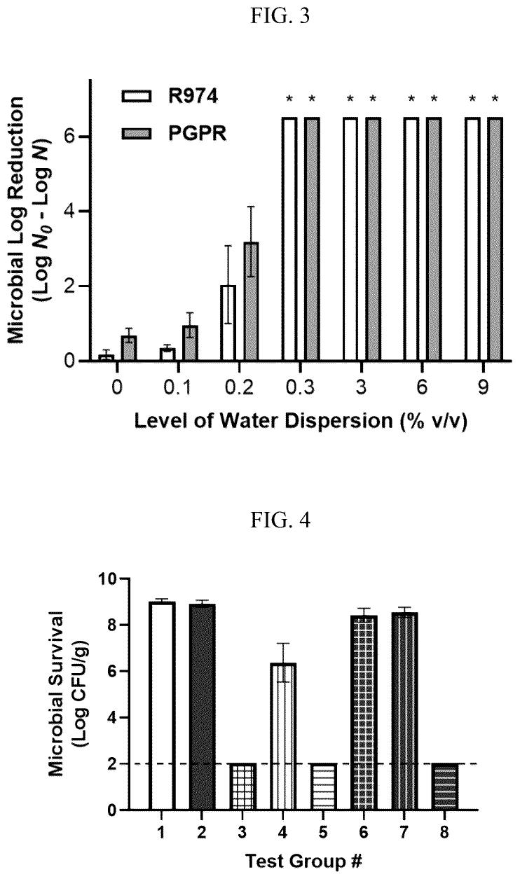

The influence of the water dispersion levels on the efficacy of glacial acetic acid-acidified water-in-oil emulsion against desiccated Salmonella enterica subsp. enterica serovar Enteritidis phage type 30 (ATCC BAA-1045) was examined, and the results are shown in FIG. 3. All formulations contained 200 mM glacial acetic acid as per final solution volume. Treatment efficacy was evaluated based upon a 30-min contact time against the bacterial cells desiccated at 75% equilibrium relative humidity for 20 h prior to testing. The inoculum level was 7 log CFU per stainless-steel coupon, and the detection limit was 0.5 log Most Probable Number/coupon. *Bacterial survival was reduced to below the detection limit, i.e., a reduction of >6.5 log MPN/coupon. As shown in FIG. 3, the lowest levels of bacterial survival were achieved with the water dispersion was at least 0.3% (v/v).

### Identification of Salmonella Surrogate

A bacterial desiccation system was first used to screen surrogates for Salmonella to evaluate the oil-based antimicrobials, as shown in Table 3. The biosafety level-1 E. faecium and E. coli were desiccated at controlled ERH levels on stainless steel and tested alongside S. Enteritidis for comparison of their susceptibilities to acidified oil and acidified W/O emulsion (22° C., 30 min, 200 mM acetic acid).

TABLE 3

| | | Mean microbial log reduction ± SD | | | | | |
|---|---|---|---|---|---|---|---|
| | | S. Enteritidis | | E. coli | | E. faecium | |
| Treatment | Formulation | Level of cellular desiccation (% equilibrium relative humidity) | | | | | |
| formulation | a_{w} (22° C.) | 75 | 33 | 75 | 33 | 75 | 33 |
| Non-acidified control | | | | | | | |
| Oil^{A} | 0.33 | NA | NA | NA | NA | NA | NA |
| Emulsion^{B} | 0.93 | NA | 0.16 ± 0.02^{a} | NA | 0.19 ± 0.06^{a} | NA | NA |
| Acetic acid (200 mM) | | | | | | | |
| Oil^{A} | 0.33 | 0.74 ± 0.09^{a} | 0.05 ± 0.03^{b} | 0.48 ± 0.16^{a} | 0.26 ± 0.09^{a} | 0.31 ± 0.18^{a} | 0.07 ± 0.02^{b} |
| Emulsion^{B} | 0.92 | >6.5^{a} | >6.5^{a} | >6.5^{a} | >6.5^{a} | 1.36 ± 0.14^{c} | 2.12 ± 0.23^{b} |

Per stainless-steel coupon, the initial cell number as recovered from desiccation was 7 log CFU and the detection limit was 0.5 log MPN. As the population was reduced to below the detection limit, the treatment was interpreted as >6.5 microbial log reduction (MLR). Different lowercase letters indicated statistical significance within each row (P < 0.05). When no MLR was observed from a treatment, it was labeled with not antimicrobial (NA) and thus statistical comparison was not drawn.
^{A}contains 3% w/w polyglycerol polyricinoleate (PGPR), a nonionic surface-active agent.
^{B}contains 3% w/w PGPR and 1% v/v distilled water.

As shown in Table 3, acidified oil had little to no influence against the E. faecium and S. Enteritidis desiccated to 33% ERH, and the two organisms showed similarly high resistance (P>0.05), with less than 0.1 MLR observed. As the desiccation humidity increased from 33% to 75% ERH, there was a significant increase in the efficacy of acidified oil (P<0.05) against the two organisms. The 75% ERH desiccated E. faecium was approximately 2.7 times less susceptible to acidified oil than the desiccated S. Enteritidis counterpart, but the difference was not significant (P>0.05). As for acidified W/O emulsion, desiccated S. Enteritidis were highly susceptible to the treatment (>6.5 MLR) at both desiccation humidities, in sharp contrast to the desiccated E. faecium which showed over 10,000× more survivors (P<0.05). There was a significant increase in the efficacy of acidified W/O emulsion against desiccated E. faecium as the desiccation humidity decreased from 75% to 33% ERH (P<0.05). Without wishing to be bound by theory, this phenomenon was likely driven by the differential osmotic pressure at the W/O emulsion-cell interface. As the cells were dried to a greater extent, the loss of cellular moisture increased the osmotic gradient at the W/O emulsion-desiccated cell interface which may facilitate the antimicrobial action of acidified W/O emulsion. With E. coli, its responses to both acidified oil and acidified W/O emulsion were in general similar to those of S. Enteritidis, with an exception that the 33% ERH desiccated E. coli was approximately 1.6 times more susceptible to acidified oil than the desiccated S. Enteritidis counterpart (P<0.05). Acidified W/O emulsion was highly effective against desiccated E. coli and S. Enteritidis at both desiccation humidities, with >6.5 MLR.

It appeared that there is a Gram-type specific sensitivity to acidified W/O emulsion based upon the organisms tested. However, desiccated Listeria monocytogenes was previously also found highly susceptible (>6.5 MLR) to acidified W/O emulsion. Such difference within the Gram-positive system (E. faecium vs. L. monocytogenes) may be due to the surface-layer (S-layer) proteins produced by E. faecium but not L. monocytogenes, rendering the E. faecium cellular surface more hydrophobic, thereby being less susceptible to the actions of acidified W/O emulsion.

In sum, desiccated E. faecium and S. Enteritidis showed similar resistance to the oil-based antimicrobials at the ranges of little to no log reduction. However, desiccated E. faecium exhibited overly high resistance to acidified W/O emulsion which, by comparison, reduced desiccated S. Enteritidis by >6.5 log per coupon. Thus, E. faecium was selected for use in subsequent experiments as the surrogate for Salmonella to validate acidified oil and acidified W/O emulsion with a benchtop flowing system involving inoculated peanut butter.

### Role of Inoculum Preparation in Antimicrobial Assays

Bacteria grown on nutrient agar surfaces are evidently more tolerant to environmental stresses than those grown in nutrient broths. This phenomenon has been associated with the exposure to a single and/or multiple stresses such as desiccation and oxidation that subsequently induced cross-tolerance. Alternatively, the production of biopolymers at the solid-air interface, termed extracellular polymeric substances (EPS), may protect the enclosed microbial community from environmental fluctuations. Thus, one would assume that lawn-based inoculum would give off more conservative inactivation results, which, thus, should be used in place of the cells grown as a liquid culture for evaluating the performance of food-safety intervention technologies, such as thermal processing, antimicrobial treatment, etc. Another layer of protection frequently observed across bactericidal assays is food matrix. When food constituents are involved in the testing, their structural networks may function as a barrier attenuating extracellular physical and chemical actions, thereby protecting the enclosed bacterial cells. Alternatively, bacterial aggregation in the form of clumps within food colloids may alleviate some of the stresses applied. Based upon these, antimicrobial assays must acclimate the test organism to the most possible resistant state for experimentation.

Thus, the effect of dehydrating lawn-based Salmonella inoculum prior to inoculation was tested to evaluate if this would increase its heat resistance within peanut butter. The results are shown in FIG. 4. Cells grown as liquid cultures (broth-based, white bars) or TSAYE lawns (lawn-based, black bars) were harvested, incubated at room temperature within a water-glycerol mixture at 0.30 water activity (a_{w}), pelleted, mixed with oil, and inoculated to peanut butter. The a_{w} of the peanut butter sample was 0.30 after inoculation. Test groups were as follows: 1) broth-based, not a_{w}-acclimated, not heat-treated; 2) lawn-based, not a_{w}-acclimated, not heat-treated; 3) broth-based, not a_{w}-acclimated, heat-treated; 4) broth-based, a_{w}-acclimated (30 min), heat-treated; 5) broth-based, a_{w}-acclimated (20 h), heat-treated; 6) lawn-based, not a_{w}-acclimated, heat-treated; 7) lawn-based, a_{w}-acclimated (30 min), heat-treated; 8) lawn-based, a_{w}-acclimated (20 h), heat-treated. The detection limit was 2 log CFU/g.

In this context, broth- and lawn-based inocula of S. Enteritidis were resuspended in a water-glycerol mixture adjusted to 0.30 a_{w} for acclimation at room temperature for two different timeframes, 30 min or 20 h. The a_{w}-acclimated cells were pelleted, added to oil, mixed with peanut butter to 9 log CFU/g (0.30 a_{w} after inoculation), and kept in a water bath at 72° C. for 2 h. It was found that the heat resistance of the 30-min acclimated, lawn-based inoculum was similar to that of the non-acclimated, lawn-based inoculum (P>0.05), which were reduced by the heat treatment by less than half a log cycle. However, extending the acclimation time to 20 h greatly sensitized the lawn-based inoculum to heating, to a level similar to the sensitivity of the non-acclimated, broth-based inoculum. These two groups were reduced by the heat treatment by over 7 log CFU/g. The phenomena were validated by a report that planktonic Salmonella exhibited an increase in heat resistance following incubation with humectants, which, however, was be offset by over-incubation such as for over 30 min with glycerol. Since the exposure of lawn-based inoculum to dehydration prior to inoculation was not found to alter the heat resistance of S. Enteritidis as enclosed in peanut butter, subsequent experiments were proceeded with the lawn-based inoculum method without a_{w} acclimation.

Cleaning with Heated Oil

At 60° C., canola oil was flushed through the contaminated tubing at a flow rate of 9.3 mL/s. With an inner tube diameter (ID) of 0.008 m and a cross-sectional area of 0.5 cm², the flow velocity was determined at 0.186 m/s using Eq. (1). The density and viscosity of canola oil at 60° C. were 890.4 kg/m³ and 0.0188 kg/m·s (Pa·s), respectively. Thus, the Reynolds number of the oil flush was calculated at 70.5 using Eq. (2), indicating that its flow type was laminar.

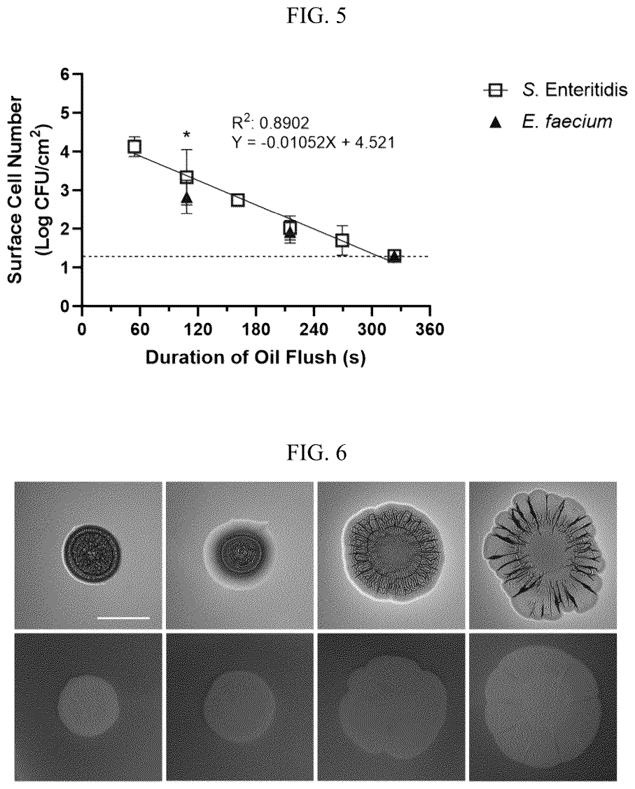

Initially, large clumps of peanut butter were purged out by the oil flush, and the turbidity of the system discharge (i.e., peanut butter-oil mixtures) decreased over time. The timepoint at which the system discharge turned visibly clear was observed at 108 s (1 L), but at this point of cleaning the tube walls remained highly contaminated, at approximately 3 log CFU/cm² as shown in FIG. 5, so did the discharge which contained approximately 5 log CFU/mL as shown in Table 2. Thus, evaluation of industrial pipeline cleanliness must not be based upon visually inspecting the system discharge as it hardly reflects the level of contamination remaining on the pipe walls, which, rather, may only be determined through environmental sampling, such as swabbing and/or enrichment.

It was found that the oil-flush duration and surface cell removal presents a linear relationship (R-squared, 0.89) (FIG. 2). Flushing 0.5, 1.0, 1.5, 2.0, 2.5, and 3.0 L of oil through the contaminated tubing, which corresponded to time domains of 52, 108, 161, 215, 269, and 323 s, respectively, reduced the numbers of S. Enteritidis to 4.13, 3.34, 2.75, 2.02, 1.70, and <1.30 log CFU/cm², respectively. At 108, 215, and 323 s of oil flush, the numbers of E. faecium were reduced to 2.83, 1.92, and <1.30 log CFU/cm², respectively. Based upon these timepoints, the cleaning efficiency in terms of cell removal by the oil flush was not significantly different between the two organisms tested (P>0.05). Likewise, the densities of the two organisms within the discharge were found similar (P>0.05) at each timepoint tested (Table 4).

These results indicated that flushing with heated oil is an effective means of removing bacterial cells and viscous food matrix such as peanut butter from tubing surfaces. However, since the procedure of tubing contamination (recirculation of inoculated peanut butter) did not include an incubation time to allow cell adhesion, one would assume that the cells were only loosely attached to the tube walls. Extrapolation of the cleaning efficiency of oil flush beyond the experimental settings, thus, should be avoided, such as that biofilms most likely will not be detached by flushing with oil flush under laminar-flow conditions.

TABLE 4

| | Cell number in the discharged oil (log CFU/mL) | |
|---|---|---|
| Oil-flush duration (s) | S. Enteritidis | E. faecium |
| 54 (0.5 L) | 6.79 ± 0.20 | 6.93 ± 0.45 |
| 108 (1.0 L) | 4.93 ± 0.84 | 5.39 ± 0.36 |
| 215 (2.0 L) | 3.18 ± 0.40 | 3.45 ± 0.32 |
| 269 (2.5 L) | <2.00 | <2.00 |

The detection limit was 2 log CFU/mL

Sanitization with Oil-Based Antimicrobials

After the oil flush, the tubing was pumped with acidified oil (500 mM acetic acid) or acidified W/O emulsion (200 mM acetic acid) for removal of residual cleaning oil, which remained holding at 60° C. for 30 min as the sanitizing treatment. The tubing exit was segmented and enriched in an undefined nutrient medium for detection (n=3×3).

The efficacy of sanitization was subject to the prevailing surface cleanliness. At 108, 215, and 269 s of oil flush, the surface numbers of S. Enteritidis were 3.34, 2.02, and 1.70 log CFU/cm², respectively; and those of E. faecium were 2.83, 1.92, and <1.30 log CFU/cm², respectively (FIG. 5). The treatment with acidified oil preceded by 269 s of oil flush did not eliminate S. Enteritidis (the number of positive enrichment=2/9) and E. faecium (9/9) from the tubing, as shown in Table 5. The treatment with acidified W/O emulsion preceded by 108 s of oil flush resulted in elimination of S. Enteritidis (0/9), while E. faecium was detected (4/9) (Table 4). Such pattern between the pathogen and the surrogate was consistent with preliminary findings that desiccated E. faecium exhibited overly high resistance to acidified W/O emulsion compared to desiccated S. Enteritidis (Table 3). However, with acidified W/O emulsion, as the preceding oil-flush duration increased to 215 s, both S. Enteritidis (0/9) and E. faecium (0/9) were eradicated from the tube walls by the sanitizing treatment (Table 6). Compared to the two-step cleaning and sanitization procedure presented above, applying acidified oil or W/O emulsion for cleaning (flushing) did not alter the rate of cell removal, neither did it influence the microbial inactivation.

TABLE 5

| Preceding oil- | Positive/total enrichments of sanitized tube samples | |
|---|---|---|
| flush duration (s) | S. Enteritidis | E. faecium |
| 108 | — | 9/9 |
| 215 | — | 9/9 |
| 269 | 2/9 | 9/9 |

—, trial was not performed.

TABLE 6

| Preceding oil- | Positive/total enrichments of sanitized tube samples | |
|---|---|---|
| flush duration (s) | S. Enteritidis | E. faecium |
| 108 | 0/9 | 4/9 |
| 215 | 0/9 | 0/9 |
| 269 | 0/9 | 0/9 |

Sufficient cleaning decreases the load of contamination to the levels allowing satisfactory sanitization to be obtained. Alternatively, incomplete soil removal may obscure microbial contaminants from the chemicals applied. It is of general consideration that, compared to stainless steels, plastics are more challenging to be cleaned due to their surface hydrophobicity rendering greater cell adhesion, and to be sterilized due to a lower level of thermal conductivity.

### Effect of Organic Acid

The efficacy of various organic acids was tested. The organic acids were of different hydrocarbon chain-lengths (Cₙ) including formic/methanoic acid (C₁), acetic/ethanoic acid (C₂), propionic/propanoic acid (C₃), butyric/butanoic acid (C₄), valeric/pentanoic acid (C₅), caproic/hexanoic acid (C₆), enanthic/heptanoic acid (C₇), caprylic/octanoic acid (C₈), pelargonic/nonanoic acid (C₉), capric/decanoic acid (C₁₀), undecylic/undecanoic acid (C₁₁), and lauric/dodecanoic acid (C₁₂). For the acids with a melting point above room temperature (i.e., C₁₀, C₁₁, and C₁₂), the oil-surfactant-acid mixture was heated to 45° C. to melt the crystalline, vortexed, and allowed cooldown back to room temperature.

For preparation of W/O emulsions, the oil-surfactant stock solution (without organic acid) was blended with 1% v/v distilled water using a high-shear mixer (M133/1281-0, Biospec Products, Inc., ESGC, Switzerland) at room temperature for 2 min. The obtained coarse W/O emulsions were further homogenized with a microfluidizer (M-110 L, Microfluidics, Newton, MA) at 12 kpsi for 2 passes. The obtained fine W/O emulsions were mixed with organic acids as previously described to make acidified W/O emulsions at 200 mM as calculated based on the sum of the volumes of the water, oil, surfactant, and acid. Analysis of emulsion particle/droplet size was performed with dynamic light scattering (DLS) using the Zetasizer Nano ZS (Malvern Instruments, Worcestershire, United Kingdom), with the results reported as the intensity-weighted mean diameter, Z average. Prior to DLS measurements, the samples were diluted 1:100 with hexadecane (refractive index=1.434, viscosity=3.13 mPa·s at 22° C.) to prevent multi-scattering.

For antimicrobial assays, a treatment solution (100 μL) was pipetted onto the desiccated cells on coupon, which was transferred to an incubator set at 22° C. or 45° C. to equilibrate for 5 min and remain holding at the prevailing temperature for 30 min. Upon end of treatment, one coupon was transferred to TSB (10 mL) buffered with 0.25 mM HEPES (pH 7.2, #H4034, Sigma-Aldrich) in a conical polypropylene tube with sterile glass beads (diameter: 1 mm). This was vortexed at 3200 rpm for 2 min to ensure the removal of cells from the coupon to the medium. Serial dilutions were made in 0.1% buffered peptone water (pH 7.2, Difco, Becton Dickinson).

Microbial survival was determined with plate counts on TSAYE with incubation at 37° C. for 24 h. Longer incubation times did not result in different viable cell numbers. The detection limit with plate counts was 2 log CFU/coupon. When microbial survival was reduced to below this point, the experiments were repeated with Most Probable Number (MPN).

Formulations comprising different chain-length acids were tested against desiccated S. Enteritidis with a 30-min treatment time. The measured solution a_{w} of acidified oil was 0.51 with C₁ and 0.33 with the remaining acids (C₂₋₁₂), that of acidified W/O emulsion was 0.92 for all the acids, and that of acidified W/O emulsion with glycerol was 0.38 for all the acids. Acidified oils formulated with the shorter chain-length acids (C₁₋₃) were found more effective than those formulated with the longer chain-length acids (C₄₋₁₂). The antimicrobial efficacy of C₁ acidified oil was pronounced, showing >6.5 MLR at both 22° C. and 45° C. The C₂ acidified oil showed 0.69 MLR at 22° C. and 1.42 MLR at 45° C. The C₃ acidified oil showed 0.89 MLR at 22° C. and 1.11 MLR at 45° C. By comparison, the C₄₋₁₂ acidified oils showed little to no MLR at 22° C. which slightly increased at 45° C. These increments with temperature elevation were likely due to the sole influence of heating as previously illustrated with the non-acidified controls.

Dispersing 1% water within acidified oils as an emulsion enhanced the antimicrobial efficacy depending on the acid carbon chain-length and treatment temperature. Acidified W/O emulsions formulated with C₁₋₃ acids showed >6.5 MLR at both 22° C. and 45° C. However, those formulated with C₄₋₁₂ acids showed little to no MLR at 22° C. but were enhanced at 45° C. (>6.5 MLR). All the emulsions were stable in terms of droplet size after a 30-min incubation at 45° C., and thus we do not believe the antimicrobial enhancement by temperature elevation was related to emulsion instability. Glycerol attenuated the antimicrobial efficacy of C₂ and C₃ acidified W/O emulsions at both 22° C. and 45° C., and attenuated that of C₄₋₁₂ acidified W/O emulsions at 45° C., to MLR levels close to the corresponding acidified oils. Such efficacy attenuation aligned with the reduced solution a_{w} upon glycerol addition. It appeared C₁ was an exception, that the a_{w} of acidified oil was greater than that of the acidified W/O emulsion with glycerol, which was in line with the corresponding MLR data. However, the difference between the antimicrobial efficacy of C₁ and C₂ acidified oils was pronounced, indicating that the solution a_{w} measured at 22° C. only partially explained the mechanism. Other factors may have been involved, e.g., the a_{w} of oil is a function of the prevailing temperature. Thus, the a_{w} of acidified oils formulated with different organic acids could exhibit different temperature dependence, thereby showing varying levels of antimicrobial efficacy. In addition, the data with C₄₋₁₂ acidified W/O emulsions suggested there may be a correlation between treatment temperature and the acid carbon chain-length. Results are summarized in Table 7.

TABLE 7

| | | Delivery system and treatment temperature (MLR ± SD)^{b} | | | | | |
|---|---|---|---|---|---|---|---|
| Organic | Chain | Oil with PGPR | | W/O emulsion | | W/O emulsion with glycerol | |
| acid^{a} | length | 22° C. | 45° C. | 22° C. | 45° C. | 22° C. | 45° C. |
| Formic | C1 | >6.52 | >6.52 | >6.52 | >6.52 | 1.32 ± 0.65 | >6.52 |
| Acetic | C2 | 0.69 ± 0.19 | 1.42 ± 0.14 | >6.52 | >6.52 | 0.81 ± 0.24 | 2.53 ± 0.75 |
| Propionic | C3 | 0.89 ± 0.24 | 1.11 ± 0.27 | >6.52 | >6.52 | 0.73 ± 0.22 | 1.41 ± 0.66 |
| Butyric | C4 | NA | 0.52 ± 0.13 | 0.55 ± 0.06 | >6.52 | 0.31 ± 0.16 | 1.40 ± 0.31 |
| Valeric | C5 | NA | 0.31 ± 0.02 | 0.11 ± 0.05 | >6.52 | NA | 1.12 ± 0.16 |
| Caproic | C6 | 0.21 ± 0.09 | 0.68 ± 0.08 | 0.72 ± 0.18 | >6.52 | 0.10 ± 0.03 | 0.74 ± 0.48 |
| Enanthic | C7 | NA | 0.34 ± 0.03 | 0.34 ± 0.26 | >6.52 | NA | 0.79 ± 0.22 |
| Caprylic | C8 | 0.26 £ 0.18 | 0.49 ± 0.26 | 0.94 ± 0.26 | >6.52 | 0.56 ± 0.18 | 0.74 ± 0.11 |
| Pelargonic | C9 | NA | 0.39 ± 0.11 | 0.31 ± 0.10 | >6.52 | NA | 0.30 ± 0.09 |
| Capric | C10 | 0.23 ± 0.04 | 0.28 ± 0.09 | 0.67 ± 0.17 | >6.52 | 0.37 ± 0.06 | 0.57 ± 0.09 |
| Undecylic | C11 | NA | 0.31 ± 0.03 | 0.38 ± 0.09 | >6.52 | NA | 0.22 ± 0.18 |
| Lauric | C12 | 0.16 ± 0.06 | 0.40 ± 0.17 | 1.05 ± 0.28 | >6.52 | 0.49 ± 0.12 | 1.02 ± 0.04 |

^{a}The organic acid concentration was 200 mM based upon the final solution volume.
^{b}30-min contact time against cells desiccated to 75% ERH.

In sum, the present inventors showed that tubing systems contaminated with Salmonella-inoculated peanut butter can be “dry” cleaned and sanitized using oil as the predominant solvent. However, as with traditional aqueous-based sanitation, insufficient cleaning would preclude the success in sanitizing treatments. Consistency in the more conservative inactivation pattern of E. faecium NRRL B-2354 compared to S. Enteritidis under all the conditions tested supported the use of this strain of E. faecium as a surrogate to validate such processes in the food manufacturing system.

The acidified oil and acidified water-in-oil emulsions of the present disclosure were subsequently evaluated for efficacy against hydrated and desiccated Salmonella biofilms. Materials and methods used for these experiments are described below.

Bacterial cultures and inoculum preparation: Salmonella enterica subsp. enterica serovar Michigan (BAA-709; cantaloupe), S. Montevideo (BAA-710; clinical isolate, tomato-associated), S. Gaminara (BAA-711; dried orange juice), and S. Enteritidis phage type 30 (BAA-1045; raw almonds) were obtained from the American Type Culture Collection (Manassas, VA). A green fluorescent protein (GFP)-labeled strain of S. Enteritidis phage type 30 (strain No. MB323) was obtained from Professor Linda Harris at the University of California, Davis, which was originally from the lab of Maria Brandl at the Western Regional Research Center, ARS, USDA. Cryocultures were made with tryptic soy broth (TSB, Becton Dickinson, Sparks, MD) with 25% v/v glycerol (Sigma-Aldrich, St. Louis, MO) and maintained at −80° C. These were streaked on tryptic soy agar (TSA, Becton Dickinson) plates with overnight incubation at 37° C. for use as working cultures, which were maintained at 4° C. and replaced every month. Prior to each experiment, an isolated colony was transferred to TSB with incubation at 37° C. for 18 hours for use as the inoculum unless otherwise specified.

Colony morphology assay: Luria-Bertani (LB) agar without sodium chloride (10 g/L tryptone, 5 g/L yeast extract) was supplemented with 40 μg/mL Congo Red (Cat. No. AAB2431014, Fisher Scientific, Hampton, NH) and 20 μg/mL Coomassie Brilliant Blue (Cat. No. P120278, Fisher Scientific) for observation under normal light, or supplemented with 200 g/mL Calcofluor White (Cat. No. 50-196-4458, Fisher Scientific) for observation under light at 365 nm using a hand-held UV lamp (Cat. No. EW-09817-01, Analytik Jena, Germany). The inoculum was pre-adjusted to optical density at 600 nm (OD₆₀₀) of 0.1 for spot-inoculating (5 μL) the agar plates for colony formation at 22° C. for 96 hours.

Biofilm formation and acclimation: The CDC Biofilm Reactor (CBR, BioSurface Technologies, Bozeman, MT) was operated based on ASTM E3161 with modifications, for Salmonella biofilm formation on stainless-steel coupons (Cat. No. RD128-316, BioSurface Technologies). Unless otherwise specified, LB broth without sodium chloride (10 g/L tryptone, 5 g/L yeast extract) was used as the growth medium. A baffled stir bar is used with a magnetic stir plate at 130 rpm to generate turbulent flow within the CBR vessel (Johnson et al., 2021). A vessel with a working volume of 360 mL was inoculated (1 mL) and incubated at 22° C. for 24 h. This was followed by continuous flow of the growth medium at 12 mL/min with incubation at 22° C. for an additional 24 hours.

After CBR growth, the coupons were rinsed twice with distilled water for removal of loosely attached cells, and air-dried at 22° C. for 40 min to allow evaporation of excess moisture for observation as Hydrated Biofilms. Distilled water was used for rinsing instead a buffered saline solution to avoid triggering osmotic stress response due to a continuous increase in the solute concentration during drying.

Desiccation: Hydrated biofilms were transferred to a desiccator which was maintained at 33% equilibrium relative humidity (ERH) with a saturated solution of magnesium chloride (Cat. No. 7786-30-3, Sigma-Aldrich), and held at 22° C. for 96 hours for observation as Desiccated Biofilms.

Rehydration: Desiccated biofilms were submerged in distilled water at 22° C. for 20 min for rehydration, and air-dried at 22° C. for 40 min to remove excess moisture for observation as Rehydrated Biofilms.

Acidified oil and diluted acidified water-in-oil emulsions were formulated according to the following procedure. All sample preparations within this context were performed at 22° C. Specifically, glacial acetic acid (Cat. No. A38-500, Fisher Scientific) was dissolved in canola oil to 200 mM for use as acidified oil. This was further mixed with 1% w/w polyglycerol polyricinoleate (PGPR, Palsgaard, Denmark) and 1% v/v distilled water for use as A-W/O emulsion. The concentrations were calculated based on the sum of the oil, acid, surfactant, and water. The water activity (a_{w}) values of the oil and W/O emulsion were 0.33 and 0.92, respectively, as measured at 22° C. by a Dewpoint a_{w} meter (Meter Group, Pullman, WA). The addition of acetic acid did not influence the respective a_{w} values.

Efficacy of acidified oil and acidified water-in-oil emulsions against the grown and acclimated biofilms was determined based on ASTM E2871. Biofilm-laden coupons were submerged in a heating menstruum (i.e., oil, W/O emulsion, or the acidified counterparts thereof) for holding at 60° C. with stagnant fluid flow. The treatment temperature was selected based on the temperature range of low-moisture food processing as frequently tested under laboratory conditions for evaluating the thermal death of Salmonella spp. in low-a_{w} foods and on surfaces.

Sampling was and performed at 0 (non-treated), 5, 30, and 60 min upon contact. Treated coupons were rinsed with canola oil under ambient conditions and transferred to a conical tube with buffered TSB (7.3 pH, 10 mL). Cells were dislodged by vortex with glass beads for 2 min. This was serially diluted with 0.1% peptone water (Becton Dickinson) and plated (100 μL) on TSA plates with incubation at 37° C. for 24 h (limit of detection (LOD): 100 CFU/coupon). Alternatively, the coupons with dislodged cells in TSB were incubated at 37° C. for 24 h for detection as positive or negative growth (LOD: 1 CFU/coupon). Microbial log reduction (MLR) was calculated as:

$$MLR = Log ( {N}_{0} / N ) = Log {N}_{0} - Log N$$

where N₀ is the viable cell number of a hydrated, desiccated, or rehydrated biofilm at time 0, and N is the respective survival cell number upon end of treatment.

Protein fixation was performed by submerging biofilm-laden coupons in 4% glutaraldehyde (Cat. No. G6257, Sigma-Aldrich) in 0.2 M sodium cacodylate (pH 7.4) (Cat. No. C0250, Sigma-Aldrich) for 3 h. This was followed by lipid fixation with 2% osmium tetroxide (Cat. No. 75632, Sigma-Aldrich) in 0.2 M sodium cacodylate for 1 h. Graded ethanol series dehydration was performed from 30-100% with a 10% interval for 10-min incubation each. Post-drying was performed with hexamethyldisilazane (HMDS) (Cat. No. 440191, Sigma-Aldrich) for 20 min. Subsequently, the coupons were mounted to SEM specimen stubs with a conductive double-sided tape (Cat. No. 77825-12, Electron Microscopy Sciences, Hatfield, PA) and coated with gold under argon for 30 s using a sputter coater (108auto, Cressington Scientific Instruments, UK). All these sample preparations were done at 22° C. Observation by SEM was performed with a benchtop unit (JCM-6000, JEOL, Japan) at 10 kV.

For biofilm thickness and gradient assays, the GFP-labeled S. Enteritidis phage type 30 (MB323) was used for CBR growth as previously described, with the growth media supplemented with 15 μg/mL gentamicin (Cat. No. 15-750-060, Fisher Scientific) to prevent the growth of the cells that did not take up the pGT-KAN plasmid during transformation. The CBR coupons were mounted on a microscope slide for observation by a confocal microscope (AX R-NSPARC/Ti2-E, Nikon, Japan). Z-stack acquisition was performed through empirically defining the top and bottom planes of a biofilm with suggested step size. The scan area was 295×295 μm² (60× oil immersion objective) at 1024×1024 pixels. One-photon excitation at 488 nm was applied. A laser power of 1.5% was used for screening fields of view and imaging, since prolonged scanning at this intensity did not induce observable photoconversion of the GFP emission spectra from green to red fluorescence upon oxygen deficiency towards the innermost of a biofilm. All the confocal specimen preparation procedures in this context were performed in dark to minimize photobleaching.

Graphing and statistical analysis were performed with Prism (Version 10, GraphPad Software, San Diego, CA). Biofilm formation and remediation assay was conducted with biological and technical triplicates (n=3×3). Two-way analysis of variance (ANOVA) was used to determine the influence of contact time and matrix hydration level on the anti-biofilm activity of acidified oil. Biofilm thickness assay was conducted in biological triplicate with ten technical replicates (n=3×10). One-way ANOVA was used to determine the influence of matrix hydration level on biofilm thickness. Tukey's post hoc test was used for pairwise comparison. Differences were determined not significant at a P value of greater than 0.05.

The abilities of different serovars under S. enterica subsp. enterica to produce curli fimbriae and cellulose were evaluated based on their colony morphology upon growth (22° C., 96 h) on LB agar without salt (FIG. 6). On the medium supplemented with Congo Red and Coomassie Brilliant Blue, i.e., protein fibril-binding dyes, the colonies of S. Michigan, S. Montevideo, S. Gaminara, and S. Enteritidis exhibited a red, dry, and rough (rdar) surface pattern. In addition, their colonies formed on the medium supplemented with Calcofluor White, i.e., a cellulose-binding dye, emitted blue fluorescence upon exposure to UV light.

Curli and cellulose are extracellular polymeric substances (EPS) which have been reported to be key contributing factors in the formation of biofilm by Salmonella spp. The growth medium and temperature were selected based upon reports that csgD, a transcriptional regulator controlling the expression of curli and cellulose genes, exhibits maximal activity upon hypo-osmolarity and at temperatures below 30° C. The incubation time was selected to allow transition in colony morphology from a smooth surface pattern to the rdar morphotype. Under these growth conditions, the Salmonella strains that are curli-negative would exhibit a pink, dry, and rough (pdar) morphotype, those that are cellulose-negative would exhibit a brown, dry, and rough (bdar) morphotype, and those that are both curli- and cellulose-negative would exhibit a smooth and white (saw) morphotype.

Strain-specific colonial development was identified, despite similarity in the rdar morphotype confirming curli and cellulose productions by all the strains tested. A complex surface pattern was developed across the entirety of the colonies formed by S. Michigan and S. Gaminara. This structure was also observed in S. Montevideo but only at the central region of its colony, with the periphery showing a smooth surface pattern which indicated a slower rate in the formation of the rdar morphotype. By comparison, the colony morphology S. Enteritidis reflected less of a concentric ring but a more aggressive, aggregative fibrillar expansion, with a lack of surface complexity at the colony center which remained consistent upon repeating the assay while extending the incubation period to 10 days. The S. Enteritidis colony also showed the greatest colonial development in terms of diameter compared to the other strains, which could be explained by a higher rate of proliferation in the peripheral cells. An alternative explanation for such apparent inter-strain morphological difference is that the rdar morphotype has been linked to an enhancement in environmental persistence, e.g., desiccation, given that S. Enteritidis BAA-1045 was sourced from raw almonds while the other stains were isolates from produce. The phenotypic traits of the strain BAA-1045 were likely indicative of a greater level of metabolic activity and lateral expansion in the surface-adapted physiological state, and, thus, it was as selected for use in subsequent biofilm formation assay.

After CBR growth (22° C., 48 h), a bacterial population of 8.1 log CFU/stainless-steel coupon was recovered from the biofilm formed by S. Enteritidis, as shown in Table 8. Desiccation (33% ERH, 22° C., 96 h) reduced the S. Enteritidis biofilm population from 8.1 to 6.3 log CFU/coupon, as shown in Table 8.

TABLE 8

| | Baseline cell number (log CFU/coupon) |
|---|---|
| Hydrated biofilm | 8.1 ± 0.2 |
| Desiccated biofilm | 6.3 ± 0.3 |

The present biofilm formation and desiccation assay demonstrated a methodological capability of producing a high, stable level of population within desiccated Salmonella biofilms formed on stainless-steel surfaces. This enables future evaluation of intervention technologies to be performed against desiccated Salmonella biofilms where a 5-log reduction is usually required to validate process lethality.

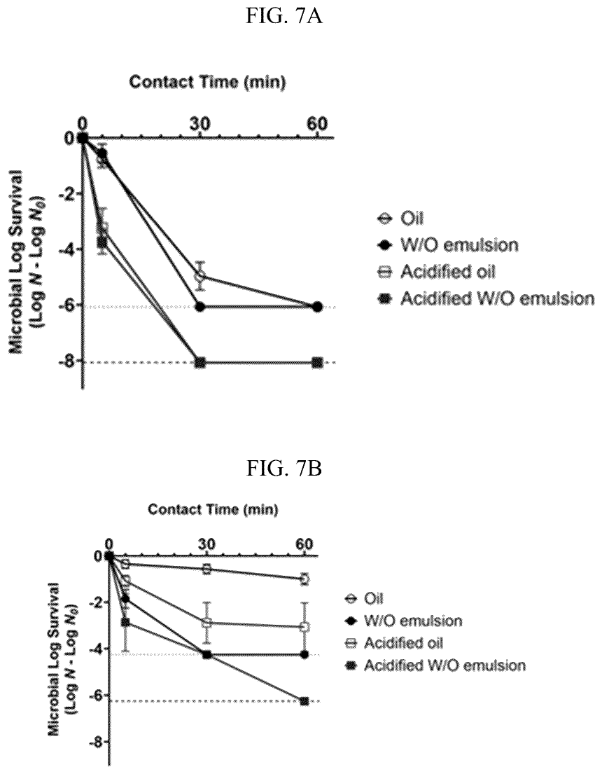

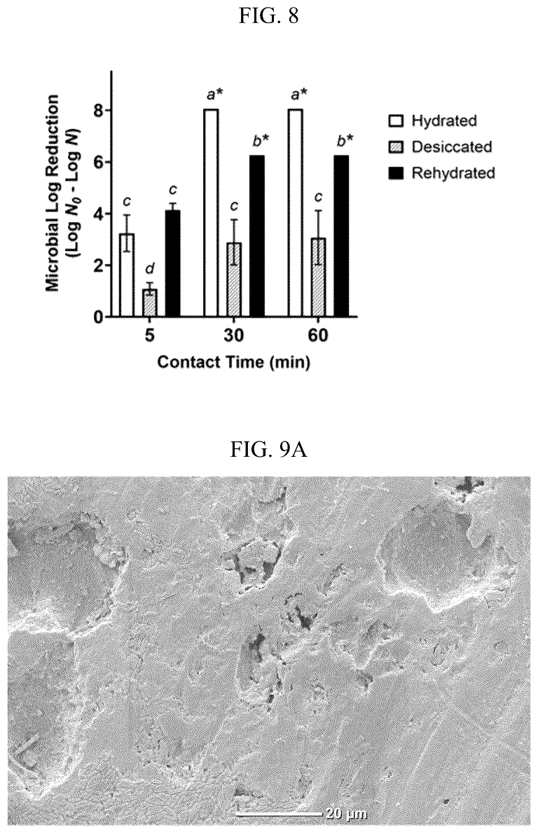

The non-desiccated (hydrated) and desiccated Salmonella biofilms were subjected to thermal treatment at 60° C. as submerged in oil, W/O emulsion, and their acidified counterparts. Prevailing moisture, either intrinsic (i.e., the biofilm matrix) or extrinsic (i.e., the heating menstruum), showed pronounced influence on the thermal death of biofilms, and such bacterial inactivation was facilitated upon acidifying the heating menstruum with acetic acid (200 mM). Without the acid, a low-a_{w} heating menstruum (oil) reduced hydrated biofilms by 0.76, 4.97, and >6.07 MLR upon contact for 5, 30, and 60 min, respectively (FIG. 7A); by comparison, desiccated biofilms exhibited enhanced thermal tolerance in oil which were reduced by 0.35, 0.57 and 1.00 MLR, respectively (FIG. 7B). Boosting the a_{w} of the heating menstruum by creating W/O emulsion increased the thermal death of desiccated biofilms at 5, 30, and 60 min by 1.50, 3.69, and 3.26 MLR, respectively (FIG. 7B), whereas the respective MLR increments observed in hydrated biofilms were not as pronounced (FIG. 7A). With acetic acid, acidified oil reduced hydrated biofilms by 3.24 MLR and to a level negative upon enrichment (>8.07 MLR) with 5 min and >30 min of contact, respectively (FIG. 7A). The efficacy of A-W/O emulsion against hydrated biofilms was found similar to that of acidified oil (FIG. 7A). Overall, there was a notable difference between the antimicrobial resistance of hydrated and desiccated biofilms. The influence of extrinsic moisture on sensitizing a dry biofilm was manifested by the MLR differential obtained from the desiccated biofilms treated with acidified oil and A-W/O emulsion (FIG. 7B). Rehydration, in addition, was found to offset the enhanced tolerance of desiccated biofilms to the low-a_{w} acidified oil treatment (FIG. 8). In order to eliminate the Salmonella biofilms regardless of matrix hydration and dehydration, a contact time of 60 min with A-W/O emulsion was needed.

Note that the hydrated and rehydrated biofilms underwent a drying process to allow evaporation of excess moisture prior to challenge testing. A drying time of 40 min was selected based on a dry surface test method documented in the U.S. EPA Guideline OCSPP 810.2300 to reflect and evaluate whether such a brief exposure/acclimation time is sufficient to dehydrate bacterial biofilms beyond just removing visually inspectable moisture and allow for acquisition of enhanced tolerance. The present results demonstrated a substantial difference between the inactivation kinetics of briefly-dried wet biofilms (i.e., hydrated and rehydrated) and desiccated biofilms (FIGS. 7A, 7B, and 8). Based upon this, it was hypothesized that the activation of desiccation-associated stress response may not be fully triggered and stabilized within initial exposure to dehydration, which, rather, may progress towards equilibration of the target vapor pressure at the cell-air interface.

Biofilm Morphology Pre- and Post-Treatment with Acidified W/O Emulsion

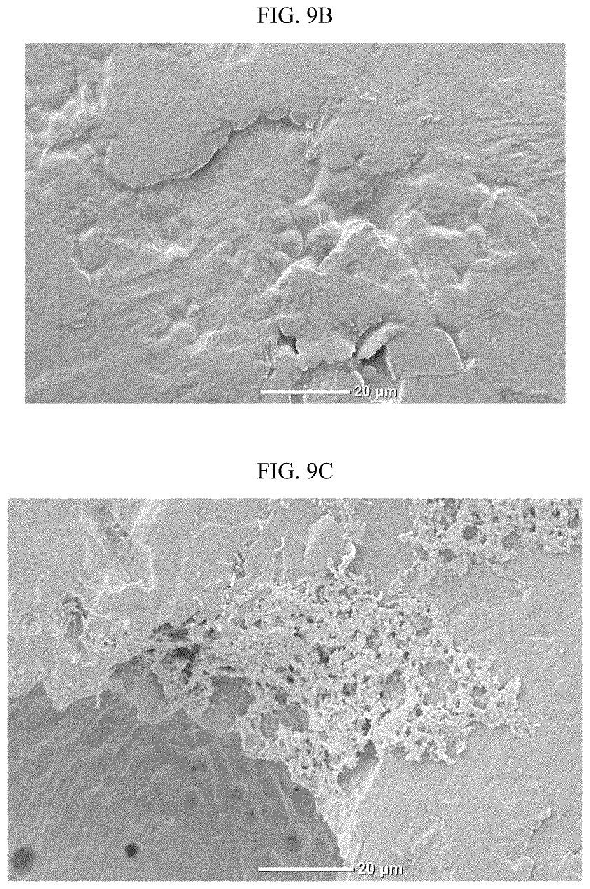

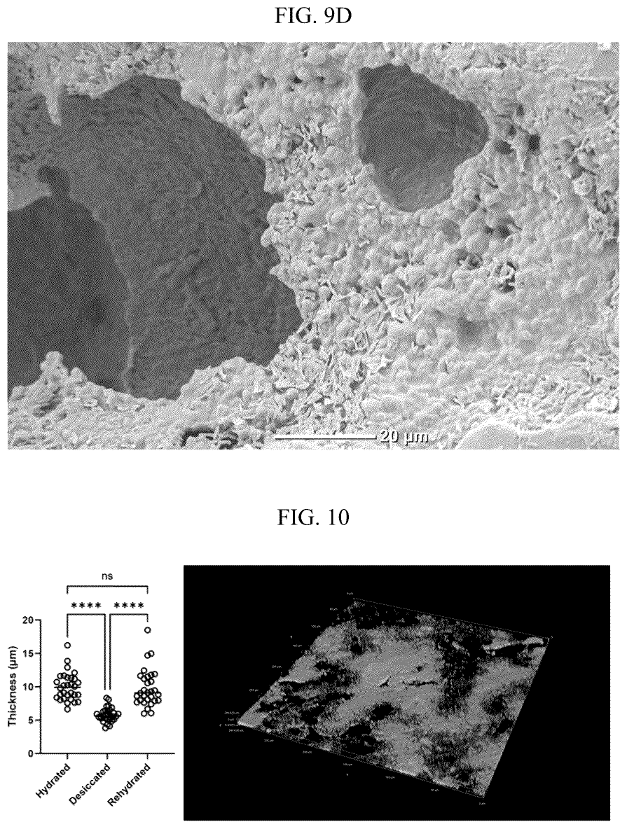

Stainless-steel coupons were found laden with spatially-structured biomass comprising individual and clustered cells and EPS after CBR growth (22° C., 48 h), i.e., a hydrated biofilm (FIG. 9A). Upon desiccation (33% ERH, 22° C., 96 h), the biofilm morphology transitioned to a smooth, lumpy network occupying the entire substratum surface, with the formation of microcolonies identified across the field of view as observed by SEM (FIG. 9B), which was confirmed with confocal microscopy. One explanation for this observation is that, with a close to 2-log reduction in the biofilm cell number due to desiccation, the nutrients and signaling molecules made readily available in the environment as a consequence of lysis of dead cells may support the extracellular matrix to develop and expand further. Such a hypothesis pertaining to biofilm maturation over desiccation was also reflected in the morphological difference between the hydrated and desiccated biofilms treated with A-W/O emulsion. In the occasion of the hydrated-treated biofilm, a partial revelation of the substratum suggested that some biofilm cells and EPS were removed during incubation with the emulsion, and the adhered cells appeared in a loosely-structured network (FIG. 9C). For the desiccated-treated biofilm, the substratum remained fully covered with a more rugged layer of biomass, as compared to the hydrated, which could be attributed to a greater level of cell-to-cell and cell-to-surface adhesion forces (FIG. 9D). It is important to note that the A-W/O emulsion treatment (60° C., 1 h) applied for observation of biofilm morphology by SEM showed a full-kill upon both the hydrated and desiccated biofilms (FIGS. 7A and 7B).

### Biofilm Thickness Assay

Water is the predominant component of the biofilm matrix which enables cross-axial molecular transport. In order to elucidate the role of prevailing moisture in the differential environmental tolerance between wet and dry biofilms, it was hypothesized that the thickness of biofilm as hydrated or dehydrated may correlate with its respective antimicrobial resistance, since EPS is the immediate environment of the embedded microorganisms, through which antimicrobial agents diffuse.

An averaged thickness of 10.0±2.1 μm was obtained from the hydrated biofilm (FIG. 10). The measurements ranged from 6.7 to 16.2 μm with a median of 9.9 μm (n=30). There was a significant decrease in biofilm thickness upon desiccation (P<0.0001), to 5.8±1.0 μm average and 5.6 μm median with notably less variation ranging from 3.8 to 8.4 μm. When the desiccated biofilm was rehydrated, its thickness increased to 9.8±2.7 μm average, 9.1 μm median, and 6.0 to 18.5 μm in range, i.e., a level similar to the hydrated (P>0.05). A confocal image of a hydrated biofilm was also shown (FIG. 10). These data presented a trend of an increase and a decrease in biofilm thickness as a function of matrix hydration and dehydration, respectively, which was accompanied by that of the respective MLR differential, indicating that the antimicrobial resistance of Salmonella biofilms is contingent upon the readily available moisture likely adsorbed by EPS in the biofilm matrix. It is reasonable to propose that acetic acid in the undissociated state may penetrate the biofilm matrix though aqueous channels and pores as driven by the osmotic gradient in the localized, immediate environment.

A significant improvement is therefore provided by the present disclosure.

This disclosure further encompasses the following aspects.

Aspect 1: An acidified oleogel comprising: 20 to 55 weight percent of an organic acid; 15 to 45 weight percent an aqueous solution; 5 to 30 weight percent of a surfactant; and 1 to 25 weight percent of an oil-structuring agent comprising a fatty acid, a fatty alcohol, a derivative thereof, or a combination thereof; wherein weight percent is based on the total weight of the acidified oleogel.

Aspect 2: The acidified oleogel of aspect 1, wherein the organic acid comprises formic acid, acetic, propionic acid, lactic acid, butyric acid, valeric acid, caproic acid, enanthic acid, caprylic acid, pelargonic acid, capric acid, undecylic acid, lauric acid, or a combination thereof, preferably acetic acid.

Aspect 3: The acidified oleogel of any of aspects 1 to 2, wherein the organic acid is present in an amount of 25 to 45 weight percent, or 30 to 45 weight percent, or 32 to 43 weight percent, each based on the total weight of the acidified oleogel.

Aspect 4: The acidified oleogel of any of aspects 1 to 3, wherein the surfactant comprises a nonionic surfactant.

Aspect 5: The acidified oleogel of any of aspects 1 to 4, wherein the surfactant is derived from a polyhydric alcohol and a C₁₂₋₂₄ fatty acid.

Aspect 6: The acidified oleogel of any of aspects 1 to 5, wherein the surfactant comprises polyglycerol polyricinoleate, a sorbitan ester, lecithin, or a combination thereof.

Aspect 7: The acidified oleogel of any of aspects 1 to 6, wherein the surfactant is present in an amount of 10 to 25 weight percent, or 15 to 25 weight percent, each based on the total weight of the acidified oleogel.

Aspect 8: The acidified oleogel of any of aspects 1 to 7, wherein oil-structuring agent comprises a C₁₂₋₃₀ fatty acid, a C₁₂₋₃₀ fatty alcohol, a triglyceride comprising C₁₂₋₃₀ alkyl groups, or a combination thereof.

Aspect 9: The acidified oleogel of any of aspects 1 to 8, wherein oil-structuring agent comprises a C₁₂₋₃₀ alkyl alcohol, a C₁₀₋₃₀ alkyl carboxylic acid, or a combination thereof, preferably stearyl alcohol, stearic acid, or a combination thereof.

Aspect 10: The acidified oleogel of any of aspects 1 to 9, wherein oil-structuring agent has a melting point of greater than 20° C., preferably greater than 25° C.

Aspect 11: The acidified oleogel of any of aspects 1 to 10, wherein the oil-structuring agent is present in an amount of 1 to 20 weight percent, or 5 to 20 weight percent, or 5 to 18 weight percent, or 8 to 18 weight percent, each based on the total weight of the acidified oleogel.

Aspect 12: The acidified oleogel of any of aspects 1 to 11, wherein the acidified oleogel is a solid at a temperature of 20 to 25° C.; wherein the acidified oleogel does not flow at a temperature of 20 to 25° C.; or wherein the acidified oleogel has a melting temperature of greater than 40° C., or greater than 45° C.

Aspect 13: The acidified oleogel of aspect 1, comprising: 32 to 43 weight percent of the organic acid; 25 to 35 weight percent water; 15 to 25 weight percent of the surfactant; and 8 to 18 weight percent of the oil-structuring agent; wherein weight percent is based on the total weight of the acidified oleogel.

Aspect 14: The acidified oleogel of aspect 13, wherein: the organic acid comprises acetic acid; the surfactant is derived from a polyhydric alcohol and a C₁₂₋₂₄ fatty acid; and the comprises a C₁₂₋₃₀ fatty acid, a C₁₂₋₃₀ fatty alcohol, a triglyceride comprising C₁₂₋₃₀ alkyl groups, or a combination thereof and has a melting point of greater than 20° C., preferably greater than 25° C.

Aspect 15: A method of preparing a water-in-oil emulsion, the method comprising: contacting the acidified oleogel of any of aspects 1 to 14 with a carrier oil to provide the water-in-oil emulsion.

Aspect 16: The method of aspect 15, wherein the acidified oleogel is contacted with the carrier oil in an amount effective to provide an organic acid concentration of 50 to 500 millimolar, or 100 to 300 millimolar, or 150 to 250 millimolar, based on the total volume of the water-in-oil emulsion; and a water concentration of 0.1 to 1 weight percent, or 0.1 to 0.5 weight percent, or 0.2 to 0.5 weight percent, or 0.1 to 0.4 weight percent, each based on the total weight of the water-in-oil emulsion.

Aspect 17: A water-in-oil emulsion prepared from the acidified oleogel of any of aspects 1 to 14 or by the method of aspects 15 or 16.

Aspect 18: The water-in-oil emulsion of aspect 17, comprising: 0.5 to 5 weight percent of the organic acid; 0.1 to 3 weight percent of the surfactant; 0.1 to 3 weight percent water; 0.1 to 5 weight percent of the oil structuring agent; and a carrier oil; wherein weight percent is based on the total weight of the water-in-oil emulsion.

Aspect 19: The water-in-oil emulsion of aspects 17 or 18, wherein the water-in-oil emulsion comprises water droplets having an average diameter of 100 to 1000 nanometers dispersed in the carrier oil.

Aspect 20: A water-in-oil emulsion comprising: 0.5 to 5 weight percent of the organic acid; 0.1 to 3 weight percent of the surfactant; 0.1 to 3 weight percent water; and a carrier oil; wherein weight percent is based on the total weight of the water-in-oil emulsion.

Aspect 21: The water-in-oil emulsion of aspect 20, wherein the water-in-oil emulsion comprises water droplets having an average diameter of 100 to 1000 nanometers dispersed in the carrier oil.

Aspect 22: A method of sanitizing a surface, the method comprising: contacting the surface with the acidified oleogel of any of aspects 1 to 14 or the water-in-oil emulsion of any of aspects 17 to 21 to provide a sanitized surface; wherein the sanitized surface exhibits a microbial log reduction of greater than or equal to 5 relative to the surface prior to the contacting, preferably a microbial log reduction of greater than or equal to 6, or greater than or equal to 6.5.

Aspect 23: The method of aspect 22, wherein the surface is a food processing surface.

Aspect 24: The method of aspects 22 or 23, further comprising contacting the surface with oil optionally comprising an organic acid at a temperature of greater than 25° C. prior to contacting the surface with the acidified oleogel or the water-in-oil emulsion.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An acidified oleogel comprising:
20 to 55 weight percent of an organic acid;
15 to 45 weight percent an aqueous solution;
5 to 30 weight percent of a surfactant; and
1 to 25 weight percent of an oil-structuring agent comprising a fatty acid, a fatty alcohol, a derivative thereof, or a combination thereof;
wherein weight percent is based on the total weight of the acidified oleogel.

2. The acidified oleogel of claim 1, wherein the organic acid comprises formic acid, acetic, propionic acid, lactic acid, butyric acid, valeric acid, caproic acid, enanthic acid, caprylic acid, pelargonic acid, capric acid, undecylic acid, lauric acid, or a combination thereof.

3. The acidified oleogel of claim 1, wherein the organic acid is present in an amount of 25 to 45 weight percent, based on the total weight of the acidified oleogel.

4. The acidified oleogel of claim 1, wherein the surfactant comprises a nonionic surfactant and is derived from a polyhydric alcohol and a C₁₂₋₂₄ fatty acid.

5. The acidified oleogel of claim 1, wherein the surfactant comprises polyglycerol polyricinoleate, a sorbitan ester, lecithin, or a combination thereof.

6. The acidified oleogel of claim 1, wherein the surfactant is present in an amount of 10 to 25 weight percent, based on the total weight of the acidified oleogel.

7. The acidified oleogel of claim 1, wherein oil-structuring agent comprises a C₁₂₋₃₀ fatty acid, a C₁₂₋₃₀ fatty alcohol, a triglyceride comprising C₁₂₋₃₀alkyl groups, or a combination thereof.

8. The acidified oleogel of claim 1, wherein oil-structuring agent comprises a C₁₂₋₃₀ alkyl alcohol, a C₁₀₋₃₀ alkyl carboxylic acid, or a combination thereof.

9. The acidified oleogel of claim 1, wherein oil-structuring agent has a melting point of greater than 20° C.

10. The acidified oleogel of claim 1, wherein the oil-structuring agent is present in an amount of 1 to 20 weight, based on the total weight of the acidified oleogel.

11. The acidified oleogel of claim 1, wherein
the acidified oleogel is a solid at a temperature of 20 to 25° C.;
wherein the acidified oleogel does not flow at a temperature of 20 to 25° C.; or
wherein the acidified oleogel has a melting temperature of greater than 40° C., or greater than 45° C.

12. The acidified oleogel of claim 1, comprising:
32 to 43 weight percent of the organic acid;
25 to 35 weight percent water;
15 to 25 weight percent of the surfactant; and
8 to 18 weight percent of the oil-structuring agent;
wherein weight percent is based on the total weight of the acidified oleogel.

13. The acidified oleogel of claim 12, wherein:
the organic acid comprises acetic acid;
the surfactant is derived from a polyhydric alcohol and a C₁₂₋₂₄ fatty acid; and
the comprises a C₁₂₋₃₀ fatty acid, a C₁₂₋₃₀ fatty alcohol, a triglyceride comprising C₁₂₋₃₀ alkyl groups, or a combination thereof and has a melting point of greater than 20° C.

14. A method of preparing a water-in-oil emulsion, the method comprising:
contacting the acidified oleogel of claim 1 with a carrier oil to provide the water-in-oil emulsion.

15. The method of claim 14, wherein the acidified oleogel is contacted with the carrier oil in an amount effective to provide
an organic acid concentration of 50 to 500 millimolar, based on the total volume of the water-in-oil emulsion; and
a water concentration of 0.1 to 1 weight percent, based on the total weight of the water-in-oil emulsion.

16. A water-in-oil emulsion prepared from the acidified oleogel of claim 1.

17. The water-in-oil emulsion of claim 16, comprising:
0.5 to 5 weight percent of the organic acid;
0.1 to 3 weight percent of the surfactant;
0.1 to 3 weight percent water;
0.1 to 5 weight percent of the oil structuring agent; and
a carrier oil;
wherein weight percent is based on the total weight of the water-in-oil emulsion.

18. The water-in-oil emulsion of claim 16, wherein the water-in-oil emulsion comprises water droplets having an average diameter of 100 to 1000 nanometers dispersed in the carrier oil.

19. A method of sanitizing a surface, the method comprising:
contacting the surface with the acidified oleogel of claim 1;
wherein the sanitized surface exhibits a microbial log reduction of greater than or equal to 5 relative to the surface prior to the contacting.

20. The method of claim 19, further comprising contacting the surface with oil optionally comprising an organic acid at a temperature of greater than 25° C. prior to contacting the surface with the acidified oleogel.
